(19) United States
(12) Patent Application Publication
(10) Pub. No.: US 2020/0332604 A1
(43) Pub. Date: Oct. 22, 2020

(54) EXPANDABLE CONNECTION FOR EXPANDABLE TUBULARS

(71) Applicant: Oil States Industries, Inc., Arlington, TX (US)

(72) Inventors: Richard Murray Whiddon, Porter, TX (US); Gary Michael Thigpen, Houston, TX (US)

(21) Appl. No.: 16/853,883

(22) Filed: Apr. 21, 2020

Related U.S. Application Data
(60) Provisional application No. 62/836,891, filed on Apr. 22, 2019.

(51) Int. Cl. E21B 17/04; F16L 25/10; F16L 37/086

(52) U.S. Cl. CPC E21B 17/04; F16L 37/086; F16L 25/10

(57) ABSTRACT

One illustrative method disclosed herein includes positioning a first tubular adjacent a second tubular, wherein one of the first and second tubulars includes a plurality of radially deflectable fingers formed in an end thereof, mating the first and second tubulars into mated engagement with one another, wherein, during the mating of the first and second tubulars, the radially deflectable fingers deflect in a radial direction, and expanding the first and second tubulars by forcing an expansion mandrel through the mated first and second tubulars such that the expanded first and second tubulars have an expanded inside diameter that is greater than an initial inside diameter of the first and second tubulars.

### BACKGROUND

### 1. Field of the Disclosure

Generally, the present disclosure relates to various novel embodiments of an expandable connection for coupling expandable tubulars to one another.

### 2. Description of the Related Art

Conventional casing strings are made up of a series of individual pipe joints secured together at their ends by threaded connections. Typically, a joint of casing is approximately 40 feet in length and has a threaded male “pin” connection at one end of the joint and a threaded female “box” connection at the opposite end of the joint. In other applications, the pipe joint may have a pin connection at each end of the pipe joint, wherein the box connection is provided in the form of a short coupling that is threaded onto one of the pin connections. Some casing is made with the box connection integrally formed at one end of the casing joint. These integral box connections may be radially larger than the pipe body, i.e., they may have a greater outside diameter, or they may be approximately the diameter. In the latter case, the connection may sometimes be referred to as a flush joint connection.

In recent years, a technique was created for casing well bores by expanding the well casing pipe radially after the casing pipe string has been lowered into a well bore. The tubular casing string is enlarged radially, i.e., expanded, by moving a die (or expansion mandrel) through the string, causing the string to expand radially beyond its original radial dimensions. That is, the tubular expansion process resulted in an increase in diameter (both internal and external) of the original tubular casing from its pre-expansion dimensions. The expansion can be performed either in a cased hole or open hole. In cased hole applications, the tubular expansion technique can be used to close holes in the casing, created either by damage or by perforation. In open hole applications, the tubular expansion technique results in a large cased well bore diameter.

A casing string includes a plurality of pipe joints that are coupled to one another at a casing joint. The typical threaded engagement between a pin and box connection in a conventional casing joint is provided to maintain a secure mechanical connection that holds the casing string together and seals the internal casing area from the formation well bore environment. When the casing string is enlarged radially, a conventional threaded pin and box connection changes dimensionally in a way that can prevent the engaged components of the threaded pin and box connection from properly engaging and sealing. The radial expansion of a conventional threaded pin and box connection may also weaken or otherwise damage the pin and box structure sufficiently to permit mechanical separation.

Threaded connections for oil field applications typically rely on three types of mechanisms to achieve the desired sealed connection. For example, such connections may typically employ metal-to-metal shouldering seals or seals formed by engaged threads with high thread interference using thread compound to affect a seal in the void areas, or deformable seal rings entrapped in the thread area. All of these types of sealing mechanisms can be compromised or completely disabled by the expansion process.

Conventional threaded well pipe connections are also susceptible to splitting along the length of the box connection when the threaded connections are expanded radially. The expansion process causes high stresses to develop at geometrical stress concentrations which are necessarily created during the thread forming process. These concentrated stresses may be sufficiently high to cause rupture or fracture of the material in the threaded connection.

The present disclosure is directed to various novel embodiments of an expandable connection for coupling expandable tubulars to one another that may eliminate or at least reduce one of more of the problems identified above.

### SUMMARY

The following presents a simplified summary of at least one disclosed embodiment in order to provide a basic understanding of some aspects of the subject matter disclosed herein. This summary is not an exhaustive overview of all of the subject matter disclosed herein. It is not intended to identify key or critical elements of the subject matter disclosed herein or to delineate the scope of any claims directed to any of the subject matter disclosed herein. Its sole purpose is to present some concepts in a simplified form as a prelude to the more detailed description that is discussed later in the application.

Generally, the present disclosure is directed to various novel embodiments of an expandable connection for coupling expandable tubulars to one another. One illustrative method disclosed herein includes positioning a first tubular adjacent a second tubular, wherein one of the first and second tubulars includes a plurality of radially deflectable fingers formed in an end thereof, mating the first and second tubulars into mated engagement with one another, wherein, during the mating of the first and second tubulars, the radially deflectable fingers deflect in a radial direction, and expanding the first and second tubulars by forcing an expansion mandrel through the mated first and second tubulars such that the expanded first and second tubulars have an expanded inside diameter that is greater than an initial inside diameter of the first and second tubulars.

One illustrative apparatus disclosed herein includes a first tubular and a second tubular that is mated to the first tubular, wherein the first and second tubulars are made of a metal-containing material and wherein the mated first and second tubulars are adapted to be radially expanded such that, after the radial expansion, the expanded first and second tubulars have an expanded inside diameter that is greater than an initial inside diameter of the first and second tubulars. In this embodiment, the apparatus also includes a plurality of kerfs in an end of one of the first and second tubulars, wherein the kerfs define a plurality of radially deflectable fingers that are adapted to deflect radially when the first and second tubulars are mated together.

Yet another illustrative apparatus disclosed herein includes a first tubular that is mated to a second tubular, wherein, when mated, the first and second tubulars are permitted to move axially relative to one another, and wherein the mated first and second tubulars are adapted to be radially expanded such that, after the radial expansion, the expanded mated first and second tubulars have an expanded inside diameter that is greater than an initial inside diameter of the mated first and second tubulars. In this example, the apparatus also includes a plurality of kerfs in an end of one of the first and second tubulars, wherein the kerfs define a plurality of radially-deflectable fingers that are adapted to deflect radially when the first and second tubulars are mated together.

Another illustrative method disclosed herein includes positioning a first tubular adjacent a second tubular, wherein one of the first and second tubulars includes a plurality of radially-deflectable fingers formed in an end thereof, mating the first and second tubulars into mated engagement with one another, wherein, during the mating of the first and second tubulars, the radially-deflectable fingers deflect in a radial direction and wherein, when mated, the first and second tubulars are permitted to move axially relative to one another. In this example, the method further includes expanding the first and second tubulars by forcing an expansion mandrel through the mated first and second tubulars such that the expanded first and second tubulars have an expanded inside diameter that is greater than an initial inside diameter of the first and second tubulars.

Yet another illustrative method disclosed herein includes positioning a first tubular adjacent a second tubular, wherein one of the first and second tubulars includes a plurality of radially-deflectable fingers formed in an end thereof, and mating the first and second tubulars into mated engagement with one another, wherein, during the mating of the first and second tubulars, the radially-deflectable fingers deflect in a radial direction and wherein, when mated, the first and second tubulars are permitted to move axially relative to one another. In this example, the method also includes positioning the mated first and second tubulars at a desired location within a well, wherein, at the desired location within the well, the first and second tubulars are in a first relative axial positon relative to one another, moving at least one of the first and second tubulars so as to establish a second relative axial position between the first and second tubulars relative to one another and, with the first and second tubulars in the second relative axial position, expanding the first and second tubulars by forcing an expansion mandrel through the mated first and second tubulars such that the expanded first and second tubulars have an expanded inside diameter that is greater than an initial inside diameter of the first and second tubulars.

### BRIEF DESCRIPTION OF THE DRAWINGS

The disclosure may be understood by reference to the following description taken in conjunction with the accompanying drawings, in which like reference numerals identify like elements, and in which:

FIG. 1 is a perspective view of one illustrative embodiment of an expandable connection disclosed herein;

FIG. 2 is an exploded, perspective view of the illustrative connection shown in FIG. 1;

FIG. 3 is a cross-sectional view taken along the axial centerline of the connection, the first tubular and the second tubular when assembled before the first tubular and the second tubular have been expanded;

FIG. 4 is an enlarged view of a portion of the cross-sectional shown in FIG. 3;

FIG. 5 is an exploded, cross-sectional view of the first tubular and the second tubular taken though the fingers without various seals and elastomer bands;

FIG. 6 is a cross-sectional view of the tubulars shown in FIG. 5 after they have been mated to one another;

FIG. 7 is an enlarged, cross-sectional view of the connection between the first tubular and the second tubular;

FIG. 8 is a perspective view of one illustrative embodiment of the connection disclosed herein;

FIG. 9 is an exploded, perspective view of the illustrative embodiment of the connection shown in FIG. 8;

FIG. 10 is a cross-sectional view taken along the axial centerline of the first tubular and the second tubular when assembled before the first tubular has been expanded;

FIG. 11 is an enlarged, cross-sectional view of the connection between the first tubular and the second tubular;

FIGS. 12 and 13 are exploded, cross-sectional views of the connection before the tubulars are mated to one another;

FIG. 14 is a cross-sectional view of the tubulars shown in FIGS. 12 and 13 after they have been coupled to one another;

FIG. 15 is an exploded, perspective view of an illustrative embodiment of the connection;

FIG. 16 is a cross-sectional view of the connection taken along the axial centerline of the connection, the first tubular and the second tubular when assembled before the first tubular and second tubular have been expanded;

FIG. 17 is an enlarged, cross-sectional view of the connection between the first tubular and the second tubular;

FIGS. 18 and 19 are exploded, cross-sectional views of the connection before the tubulars are mated to one another;

FIG. 20 is a cross-sectional view of the tubulars shown in FIGS. 18 and 19 after they have been coupled to one another;

FIG. 21 is a perspective view of an illustrative embodiment when assembled;

FIG. 22 is an exploded, perspective view of an illustrative embodiment of the connection;

FIG. 23 is an enlarged portion of the perspective view shown in FIG. 22;

FIG. 24 is a cross-sectional view of an illustrative embodiment of the connection taken along the axial centerline of the connection, the first tubular and the second tubular after the tubulars have been assembled but prior to the tubulars being expanded;

FIG. 25 is an enlarged, cross-sectional view of the first tubular;

FIG. 26 is an enlarged, cross-sectional view of the second tubular that is taken through one of the kerfs;

FIG. 27 is an enlarged, cross-sectional view of the connection between the first tubular and the second tubular after the tubulars have been coupled to one another;

FIGS. 28 and 29 are exploded, cross-sectional views of the connection before the tubulars are mated to one another;

FIG. 30 is a cross-sectional view of the tubulars shown in FIGS. 28 and 29 after they have been coupled to one another;

FIG. 31 is a perspective view of an illustrative embodiment when assembled and prior to insertion into a well;

FIG. 32 is an exploded, perspective view of an illustrative embodiment of the connection;

FIG. 33 is a cross-sectional view of an illustrative embodiment of the connection taken along the axial centerline of the connection, the first tubular and the second tubular when assembled and before the tubular and the second tubular have been expanded;

FIG. 34 is a drawing depicting a particular sealing detail of an illustrative embodiment;

FIGS. 35 and 36 are exploded, cross-sectional views of the connection before the tubulars are mated to one another;

FIG. 37 is a cross-sectional view of the tubulars shown in FIGS. 35 and 36 after they have been coupled to one another;

FIG. 38 is an exploded, perspective view of an illustrative embodiment of the connection;

FIG. 39 is a cross-sectional view of an illustrative embodiment of the connection taken along the axial centerline of the connection, the first tubular and the second tubular;

FIG. 40 is a cross-sectional view that depicts, among other things, the engagement between the radially-deflectable fingers on the locking ring and a groove in the outer surface of the first tubular;

FIG. 41 is an enlarged, cross-sectional view that depicts, among other things, a portion of the assembled tubulars in one possible configuration wherein the assembled tubulars are run into the well;

FIG. 42 is an enlarged view of a portion of FIG. 41;

FIG. 43 is an enlarged, cross-sectional view of the tubulars showing the position of the pressure-retaining seal in the seal groove;

FIG. 44 is an exploded, perspective view of a portion of the illustrative locking ring disclosed in an illustrative example of the connection;

FIG. 45 is an exploded, perspective view of a portion of the illustrative tubulars as well as the illustrative sealing ring;

FIG. 46 is a cross-sectional view of a portion of the first tubular in an illustrative embodiment;

FIG. 47 is a cross-sectional view of a portion of the second tubular in an illustrative embodiment;

FIGS. 48 and 49 depict the connection in an assembled configuration wherein the tubulars are coupled to one another and the locking ring is coupled to the first tubular;

FIG. 50 depicts an illustrative embodiment of the assembled tubulars after they have been positioned in the well and radially expanded and prior to the tubulars experiencing any appreciable thermal expansion; and

FIG. 51 depicts an illustrative embodiment of the assembled tubulars after they have been positioned in the well and radially expanded and after the tubulars have undergone maximum thermal expansion due to downhole operating temperatures.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Various illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various structures, systems and devices are schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

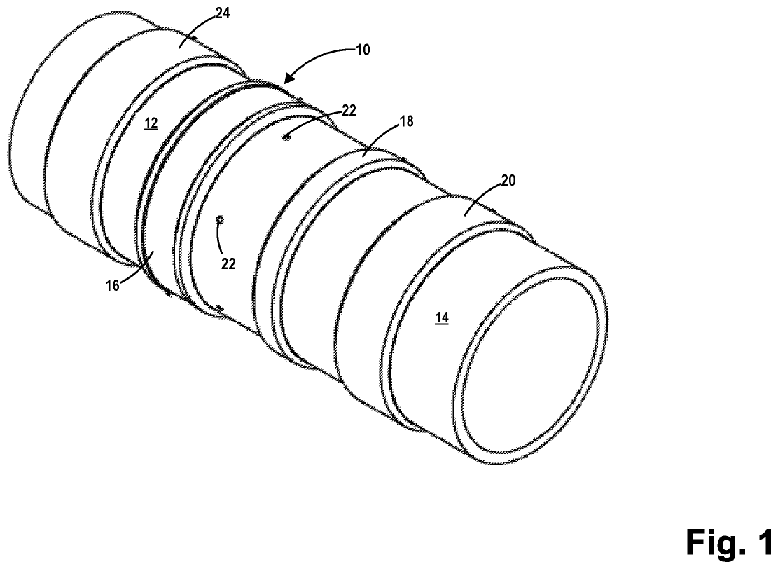

FIGS. 1-7 depict various illustrative novel embodiments of one illustrative embodiment of an expandable connection 10 for coupling a first expandable tubular 12 to a second expandable tubular 14. The expandable tubulars 12, 14 referenced and disclosed herein may be of any shape or form, e.g., casing, pipe, etc., and they may be of any size or configuration. The expandable tubulars 12, 14 may be made of any non-plastic, metal-containing material that is suitable for use in down-hole environments, e.g., carbon steel, a chromium containing metallic materials, etc. As will be appreciated by those skilled in the art after a complete reading of the present application, expandable tubulars coupled to one another using any of the various embodiments of the connection disclosed herein may be radially expanded using any known technique or method. For example, the tubulars disclosed herein may be expanded by forcing an expansion mandrel through the first and second tubulars such that, after the expansion process is completed, they have an expanded diameter that is greater than the initial (pre-expansion) diameter of the tubulars. The expansion mandrel may be forced through the tubulars in any direction, e.g., in either an up-hole or downhole direction. Of course, during the process of urging the first and second tubulars 12, 14 into mated engagement with one another, one of the tubulars may remain stationary or there may be cases where both of the tubulars 12, 14 are moved toward one another during the mating process. In some cases, the terms “pin” and “box” may be used to describe the mating relationship between the tubulars 12, 14, even though the connection 10 is not a threaded connection. The novel devices and methods disclosed herein may be employed on any type of well, e.g., cased or uncased well, and in any well irrespective of the orientation, e.g., vertical or horizontal, of any portion of the wellbore. Thus, use of relative terminology such as “vertical,” “horizontal,” “upper,” “lower,” “top” or “bottom” to refer to various components or relative positions of various features described herein should not be considered to imply any particular absolute orientation of the component, feature or wellbore.

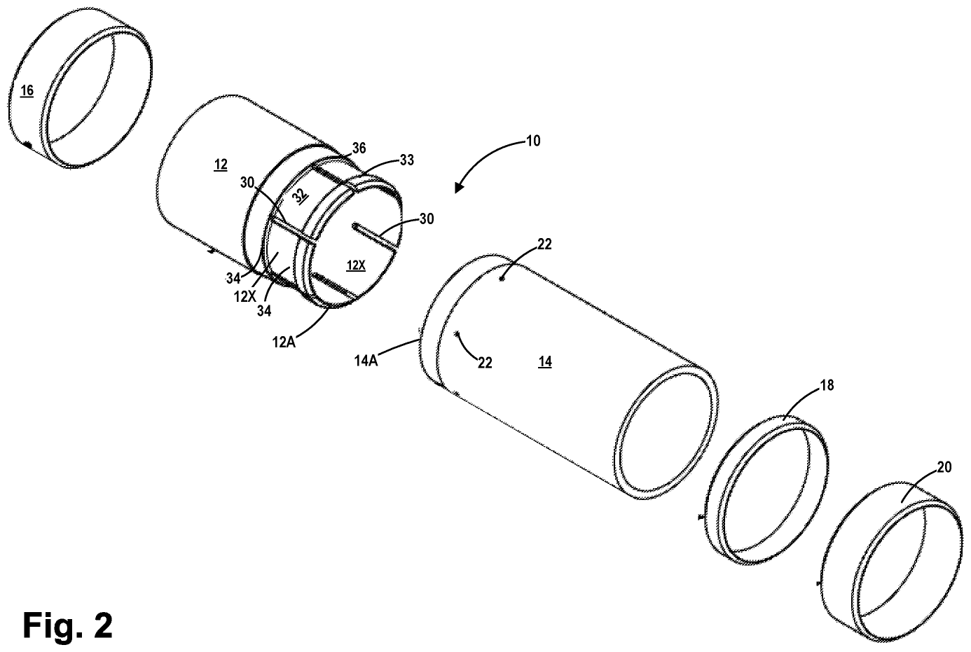

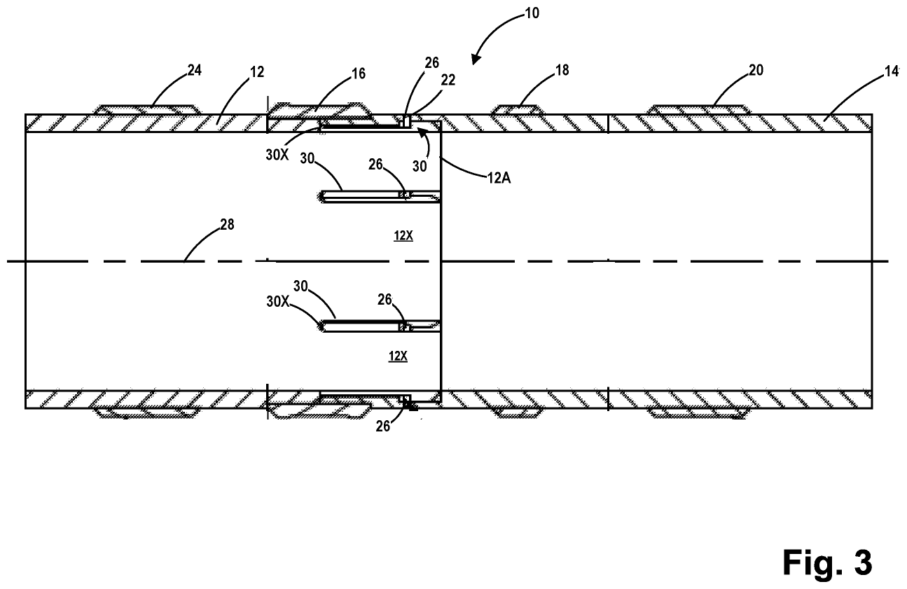

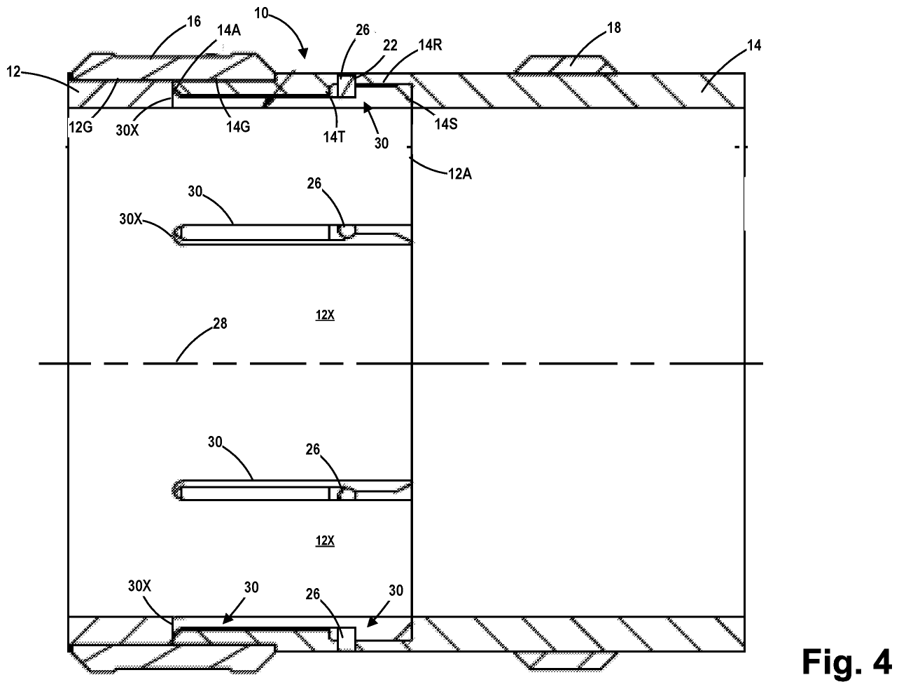

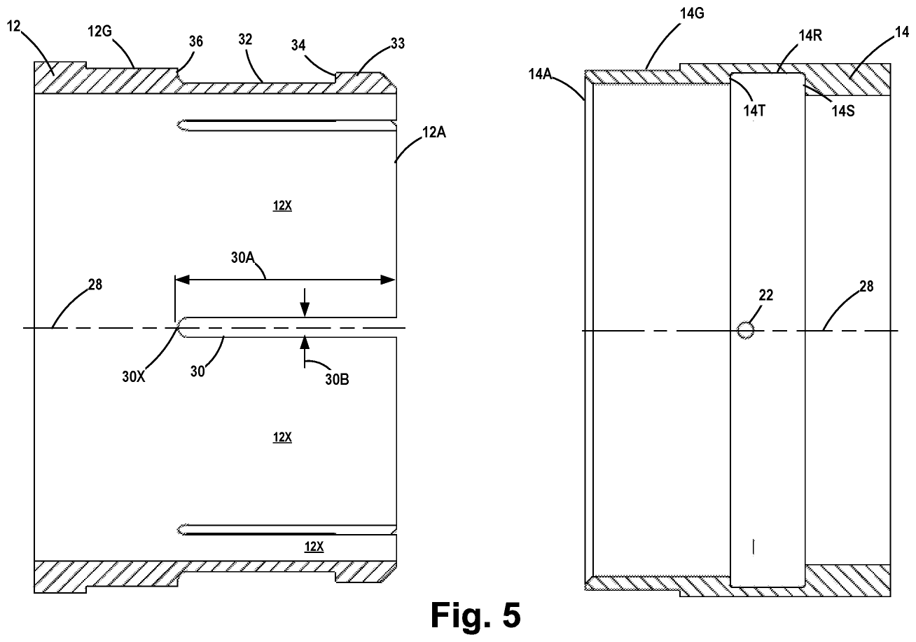

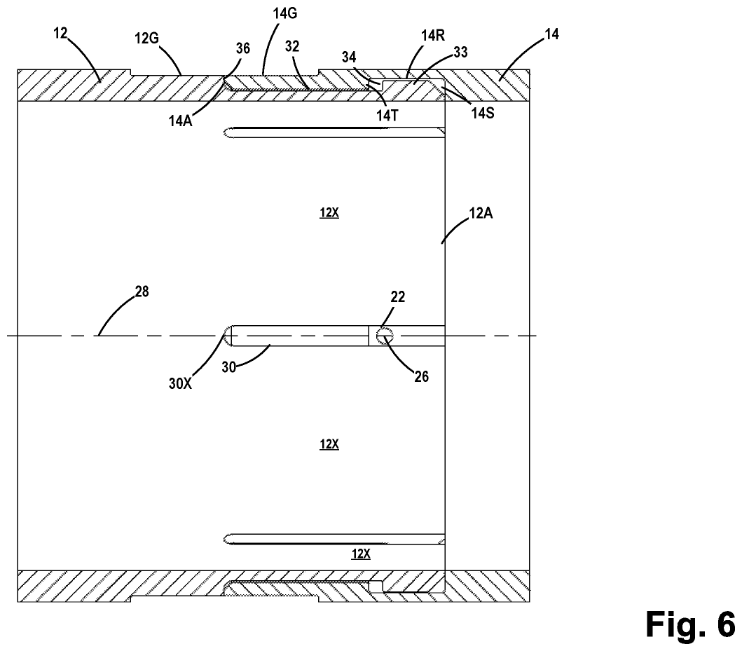

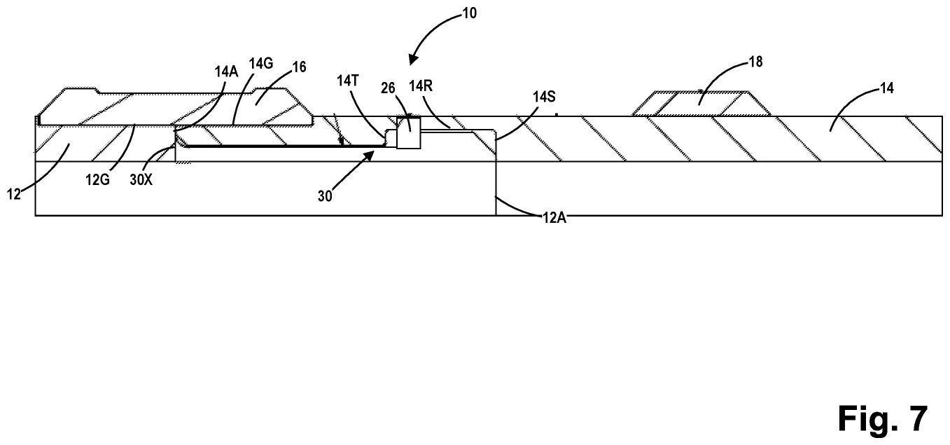

FIG. 1 is a perspective view of one illustrative embodiment of an expandable connection 10 disclosed herein that is adapted for coupling a first expandable tubular 12 to a second expandable tubular 14. In general, a plurality of kerfs 30 is formed in one of the tubulars 12, 14 so as to form a plurality of radially-deflectable fingers (12X or 14X) on the particular tubular. FIG. 2 is an exploded, perspective view of the illustrative connection 10 shown in FIG. 1. FIG. 3 is a cross-sectional view taken along the axial centerline 28 of the connection 10, the first tubular 12 and the second tubular 14 when assembled before the first tubular 12 and the second tubular 14 have been expanded. The view in FIG. 3 is also taken through the kerfs 30 formed on the first tubular 12. The relative relationship of the connection 10 between the first tubular 12 and the second tubular 14 depicted in FIGS. 2 and 3 will remaining substantially the same before, during and after expansion of the first tubular 12 and the second tubular 14, with the understanding that the components will undergo outward radial expansion, i.e., the expanded first and second tubulars 12, 14 will have an expanded inside diameter that is greater than the initial (pre-expansion) inside diameter of the first and second tubulars 12, 14. FIG. 4 is an enlarged view of a portion of the cross-sectional shown in FIG. 3. FIG. 5 is an exploded cross-sectional view of the first tubular 12 and the second tubular 14 taken though the fingers 12X without various seals and elastomer bands that are positioned on the first tubular 12 and the second tubular 14. FIG. 6 is a cross-sectional view of the tubulars 12, 14 shown in FIG. 5 after they have been mated to one another. FIG. 7 is an even further enlarged cross-sectional view of the connection between the first tubular 12 and the second tubular 14. Various aspects of this illustrative example of a connection 10 between the first tubular 12 and the second tubular 14 will be discussed more fully below.

As shown in the drawings, the connection 10 is adapted to couple the first tubular 12 and the second tubular 14 to one another. Also depicted is an outer connection seal 16, an elastomer band 18, an elastomer band 20, a threaded pin opening 22, an elastomer band 24 and a threaded anti-rotation pin 26. The number, form and/or size of the seals and elastomer bands may vary depending upon the particular application. In some applications, there may not be any elastomer bands present on the outer surfaces of the tubulars 12, 14. If used, the elastomer bands may provide a seal between the expanded tubulars and the wellbore (or casing in a cased well) that substantially prevents any fluid flow in the annular space between the expanded tubulars and the wellbore (or casing). The elastomer bands (if employed) may also perform the additional function of anchoring the expanded tubulars within the well. In some applications, the elastomer bands may only perform this anchoring function; i.e., they may or may not provide any seal against fluid flow. A pressure-retaining seal may be present in the connection 10 to prevent fluid from leaking between the inside and outside of the engaged tubulars 12, 14 before, during and after the radial expansion of the tubulars 12, 14. In the particular example shown in FIGS. 1-7, this pressure-retaining seal takes the form of the illustrative outer connection seal 16 that is adapted to, among other things, retain the pressure present in the tubulars 12, 14 during the tubular expansion process.

The axial centerline 28 of the first tubular 12 and the second tubular 14 is also shown in the drawings. Also depicted are a plurality of the above-mentioned kerfs (e.g., slots) 30 that are formed in the first tubular 12 adjacent a first end 12A of the first tubular 12. Of course, as will be appreciated by those skilled in the art after a complete reading of the present application, the kerfs 30 may be formed on either the first tubular 12 or the second tubular 14 as described more fully below. The number, form and size of the kerfs 30 may vary depending upon the particular application. In the examples depicted herein, the kerfs 30 are longitudinal slots that run substantially parallel to the axial centerline 28. The kerfs 30 have an innermost end 30X. With reference to FIG. 5, the kerfs 30 have an axial length 30A and an arcuate width 30B, the values of which may change depending upon the particular application. The formation of the kerfs 30 in an end of one of the tubulars results in the formation of a plurality of radially-deflectable fingers in the tubular, e.g., a plurality of radially-deflectable fingers 12X in the tubular 12 or a plurality of radially-deflectable fingers 14X in the tubular 14. In this particular example, each pair of adjacent kerfs 30 define a radially-deflectable finger 12X proximate the first end 12A of the first tubular 12. In general, the size and number of the kerfs 30 are selected so as to permit the desired inward radial deflection (discussed more fully below) of the fingers 12X or the desired outward radial deflection of the fingers 14X during the process of mating the tubulars 12, 14 to one another. The number and size of the threaded anti-rotation pins 26 may also vary depending upon the particular application. In the depicted example, there is a threaded anti-rotation pin 26 that is associated with each of the kerfs 30. In the example shown in FIGS. 1-7, the threaded pin opening 22 is formed in the second tubular 14. In some applications, the threaded anti-rotation pins 26 and the threaded pin openings 22 may be omitted.

With specific reference to FIGS. 4, 5 and 6, each radially-deflectable finger 12X comprises a groove 32 that is defined by a front shoulder 34 and a rear shoulder 36 and an outwardly-extending protrusion 33 between front shoulder 34 and the first end 12A. In the depicted example, an outer seal groove 12G is provided in the outer surface of the radially-deflectable finger 12X, however, such an outer seal groove 12G may not be present in all applications. The second tubular 14 comprises a shoulder 14S, a shoulder 14T and a groove 14R. In the depicted example, an outer seal groove 14G is provided in the outer surface of the second tubular 14, however, such an outer seal groove 14G may not be present in all applications. In this particular example, the combination of the outer seal groove 12G and the outer seal groove 14G is adapted to receive the outer connection seal 16. In other applications, one or both of the outer seal grooves 12G, 14G may be omitted and the outer connection seal 16 may be bonded to the outer surfaces of the connected tubulars 12, 14. In the depicted example, when the first tubular 12 and the second tubular 14 are coupled to one another, the protrusions 33 on the radially-deflectable fingers 12X of the first tubular 12 are adapted to be positioned in the groove 14R in the second tubular 14, and the portion of the second tubular 14 from the front end 14A of the second tubular to the shoulder 14T is adapted to be positioned in the groove 32 in each of the radially-deflectable fingers 12X.

In terms of assembly, in one illustrative example, the elastomer bands 18, 20, 24 may be glued or vulcanized to their respective tubulars. In this example, the outer connection seal 16 may be attached to the first tubular 12 prior to the coupling of the tubulars 12, 14 to one another. In this example, the kerfs 30 on the first tubular 12 permit the fingers 12X to deflect radially inward, i.e., toward the centerline 28, as the first tubular 12 is mated with the second tubular 14. The mating of the tubulars 12, 14, e.g., the insertion of the first tubular 12 into the second tubular 14, continues until such time as the protrusion 33 on each of the radially-deflectable fingers 12X aligns with the groove 14R in the second tubular 14, at which time the protrusions 33 effectively spring outwardly and into engagement with the groove 14R. The threaded anti-rotation pins 26 (if present) may be installed in the threaded pin openings 22 prior to or after joint assembly to thereby prevent relative rotation between the first tubular 12 and the second tubular 14. More specifically, in one situation, the anti-rotation pins 26 may be installed in the second tubular 14 prior to inserting the first tubular 12 into the second tubular 14 as long as the kerfs 30 in the first tubular 12 are designed and configured so as to accept or receive portions of the anti-rotation pins 26 during the tubular mating process. In another situation, the anti-rotation pins 26 may be installed after the tubulars 12, 14 are completely joined with one another. Thereafter, the outer connection seal 16 may then be installed in the combination of the outer seal groove 12G and the outer seal groove 14G.

This process is repeated as many time as desired so as to create an overall string of expandable tubulars of a desired overall length. At that point, the overall string of connected expandable tubulars are adapted to be positioned in a cased well or an open borehole and thereafter radially expanded. As will be appreciated by those skilled in the art after a complete reading of the present application, expandable tubulars may be coupled to one another using any of the various embodiments of the connection disclosed herein. Moreover, once the expandable tubulars have been coupled to one another, they may be radially expanded using any known technique or method. Many of the embodiments discussed below will have several elements and/or components in common with the embodiments discussed previously in this application. Thus, the comments and/or descriptions of such common elements and/or components apply equally with respect to all embodiments that share those common elements and/or components.

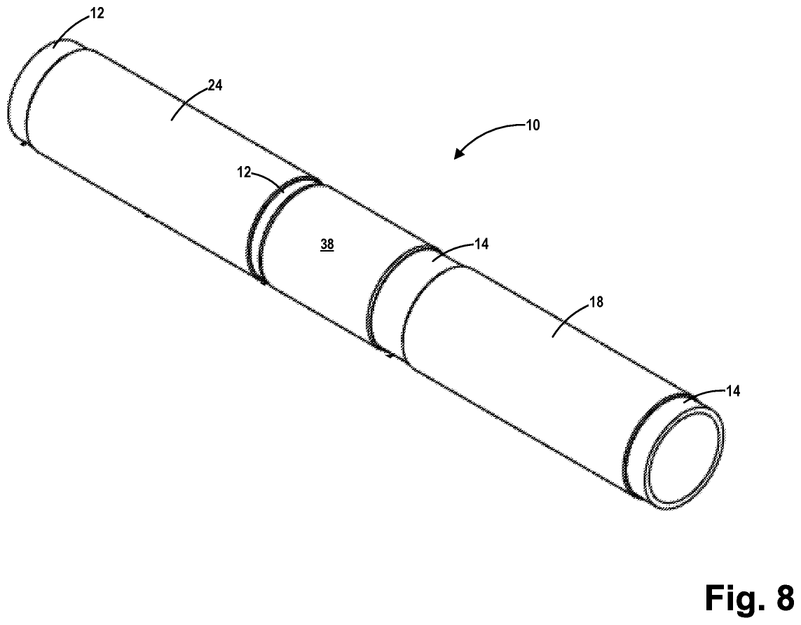

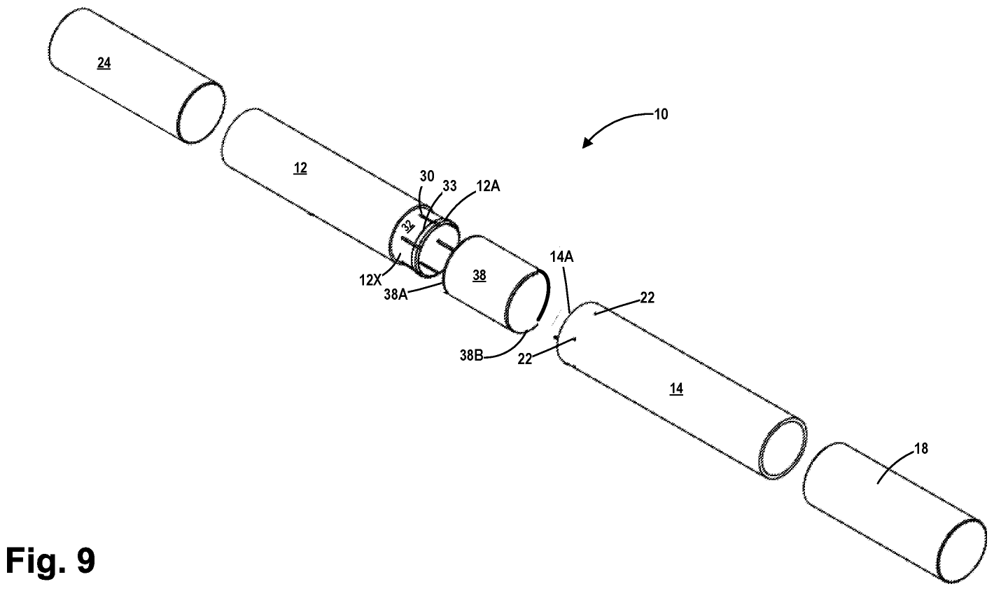

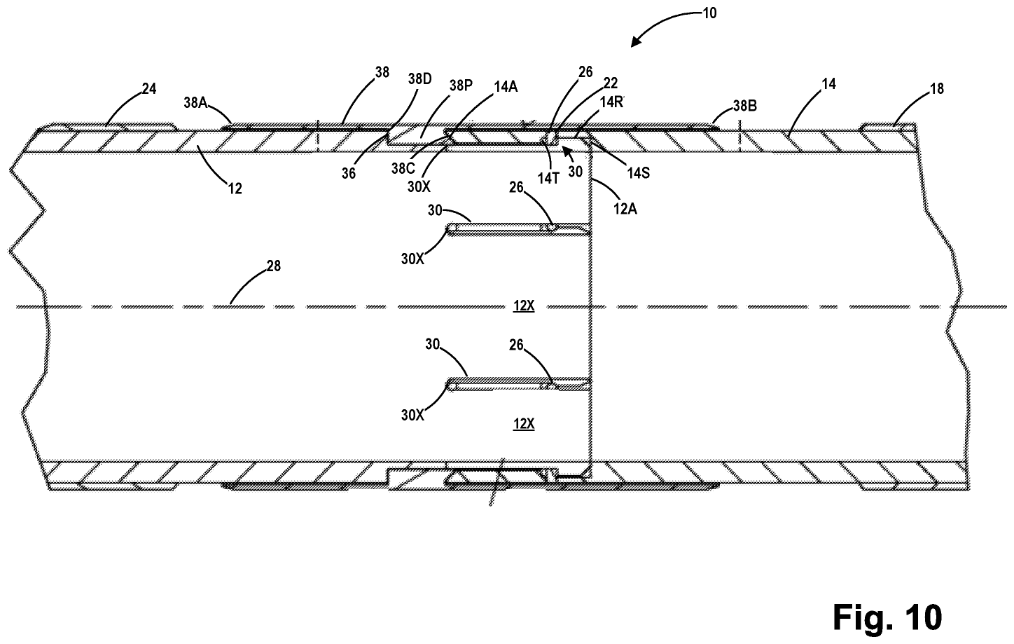

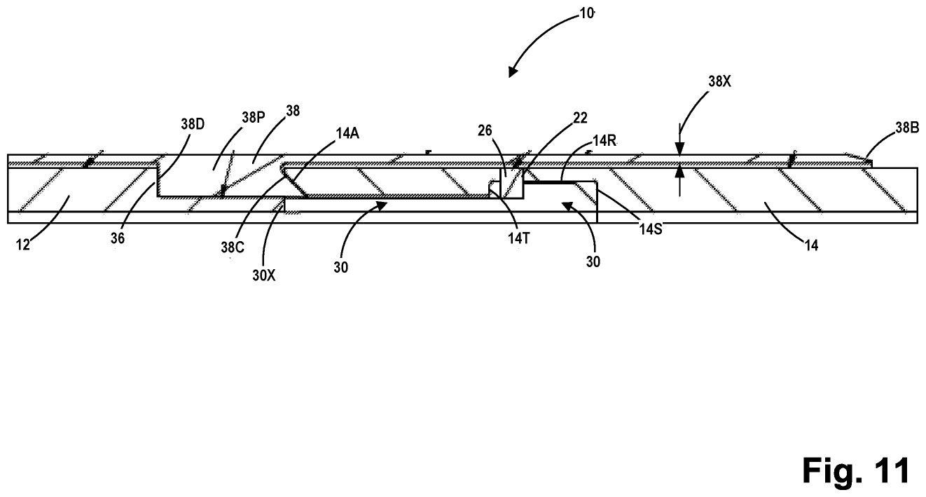

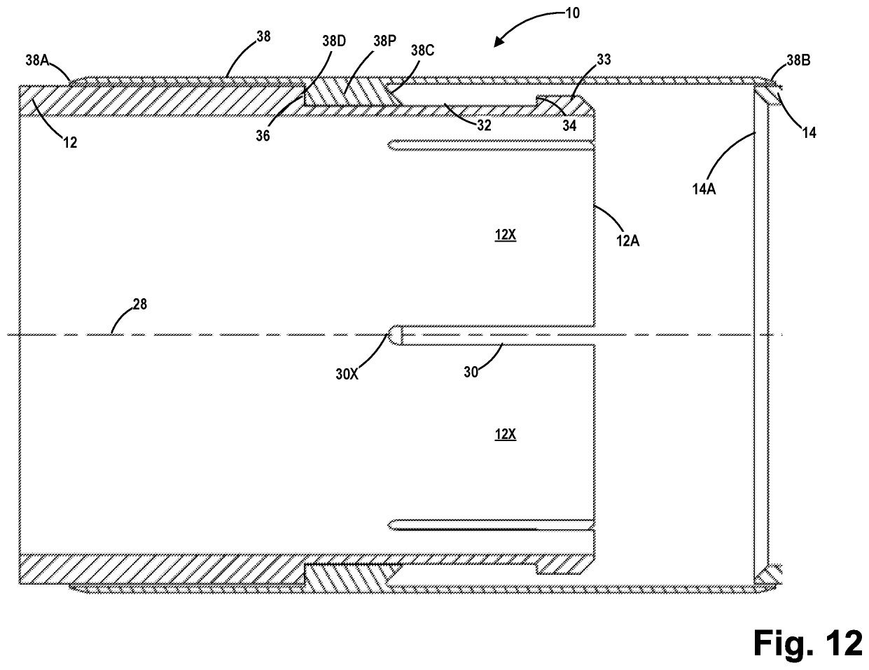

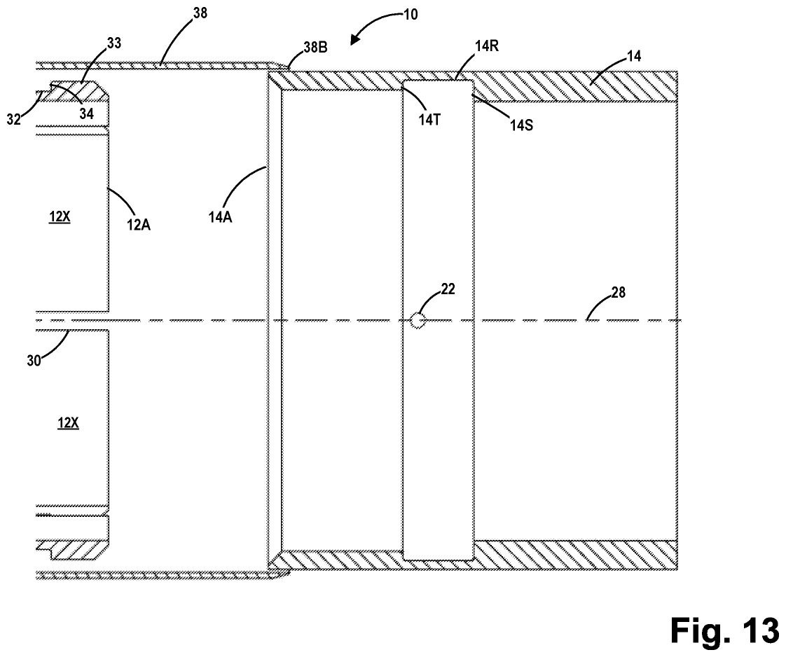

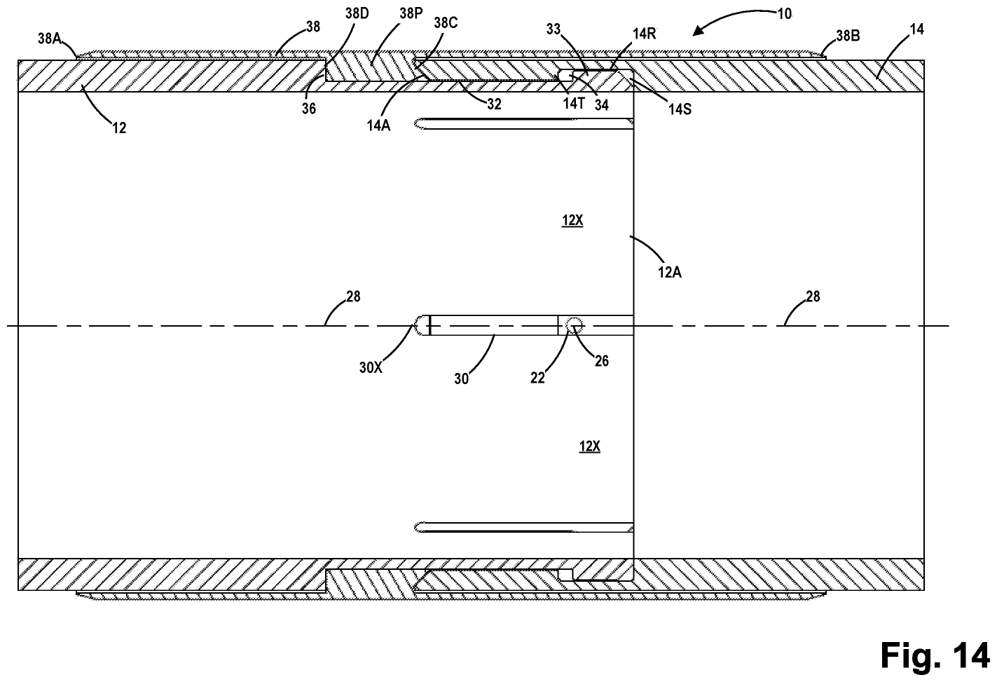

FIGS. 8-14 depict yet another illustrative novel embodiment of an expandable connection 10 for coupling expandable tubulars to one another. This embodiment is substantially the same as the one discussed above in connection with FIGS. 1-7 except that it includes a protective ring 38 and the outer connection seal 16 shown in the previous embodiment has been omitted from this embodiment. FIG. 8 is a perspective view of one illustrative embodiment of this version of a connection disclosed herein. FIG. 9 is an exploded, perspective view of the illustrative embodiment of the connection 10 shown in FIG. 8. FIG. 10 is a cross-sectional view taken along the axial centerline 28 of the first tubular 12 and the second tubular 14 when assembled before the first tubular 12 and 14 have been expanded. The view in FIG. 10 is also taken through the kerfs 30 formed on the first tubular 12. As before, the relative relationship between and among the connection 10, the first tubular 12 and the second tubular 14 depicted in FIG. 10 will remaining substantially the same before, during and after expansion of the first tubular 12 and the second tubular 14, with the understanding that the components will undergo outward radial expansion. FIG. 11 is an enlarged cross-sectional view of the connection 10 between the first tubular 12 and the second tubular 14. FIGS. 12 and 13 are exploded, cross-sectional views of the connection 10 before the tubulars 12, 14 are mated to one another. FIG. 14 is a cross-sectional view of the tubulars shown in FIGS. 12 and 13 after they have been coupled to one another. Various aspects of this illustrative example of the connection 10 between the first tubular 12 and 14 will be discussed more fully below.

As shown in FIGS. 8-14, this illustrative example of the expandable connection 10 is also adapted to couple the first tubular 12 and the second tubular 14 to one another. Although not depicted in the drawings for this embodiment, a pressure-retaining seal (not shown) that is adapted to prevent fluid from leaking between the inside and outside of the engaged tubulars 12, 14 before, during and after the radial expansion of the tubulars 12, 14 may be provided between some portion of the pin and some portion of the box. Such a pressure-retaining seal may take a variety of forms such as, for example, the illustrative pressure-retaining seals 40, 50 or 80 described more fully below. Also depicted is the plurality of kerfs 30 that are formed in the first tubular 12 adjacent a first end 12A of the first tubular 12. Of course, as noted above, the kerfs 30 may be formed on either the first tubular 12 or the second tubular 14 as described more fully below. As before, the number, form and size of the kerfs 30 may vary depending upon the particular application so as to permit the desired inward deflection of the radially-deflectable fingers 12X during the process of joining the tubulars 12, 14 to one another. As before, it should also be understood that, in some applications, the threaded anti-rotation pins 26 and the threaded pin openings 22 may be omitted.

In this illustrative embodiment, the protective ring 38 is a generally cylindrically shaped body with a first end 38A, a second end 38B and an inwardly-extending protrusion 38P. The protective ring 38 has a nominal radial thickness 38X (see FIG. 11) at locations where it is positioned outside of the outer surfaces of the first tubular 12 and the second tubular 14. The nominal thickness 38X of the outermost wall of the protective ring 38 may vary depending upon the particular application. In this particular example, the protrusion 38P has an inwardly-tapered forward shoulder 38C and a substantially vertically oriented rear shoulder 36D. In this example, the first end 14A of the second tubular 14 takes the form of an outwardly-tapered surface. As depicted, when installed, the protrusion 38P of the protective ring 38 is effectively trapped between the outwardly-tapered first end 14A of the second tubular 14 and the rear shoulders 36 of the radially-deflectable fingers 12X on the first tubular 12.

In terms of assembly, in one illustrative example, the elastomer bands 18, 24 may be glued or vulcanized to their respective tubulars. Thereafter, the protective ring 38 may be positioned on the second tubular 14 such that the tapered first end 14A of the second tubular 14 engages the inwardly-tapered shoulder 38C of the protective ring 38. At that point, the first tubular 12 may be inserted through the first end 38A of the protective ring 38. As with the previous embodiment, the kerfs 30 on the first tubular 12 permit the radially-deflectable fingers 12X to deflect radially inward, i.e., toward the centerline 28, as the first tubular 12 is mated with the second tubular 14. The insertion of the first tubular 12 into the second tubular 14 continues until such time as the protrusion 33 on each of the radially-deflectable fingers 12X on the first tubular 12 aligns with the groove 14R in the second tubular 14, at which time the protrusions 33 spring outwardly into engagement with the groove 14R. At that time, the substantially vertically oriented shoulder 38D of the protrusion 38P of the protective ring 38 will also engage the rear shoulder 36 of the first tubular 12, thereby securing the protective ring 38 in position. The threaded anti-rotation pins 26 (if present) may be installed in the threaded pin openings 22 prior to or after joint assembly to thereby prevent relative rotation between the first tubular 12 and the second tubular 14, as discussed above with respect to the previous embodiment. In this case, if the anti-rotation pins 26 are installed after the joint is assembled, openings (not shown) may be provided in the protective ring 38 to allow insertion of the anti-rotation pins 26 through the openings in the protective ring 38. As before, this process is repeated as many time as desired so as to create an overall string of expandable tubulars of a desired overall length. At that point, the overall string of connected expandable tubulars are adapted to be positioned in a cased well or an open borehole and thereafter radially expanded, wherein, in this embodiment, the protective ring 38 will also be radially expanded such that its expanded inside diameter will be greater than its initial (pre-expansion) inside diameter.

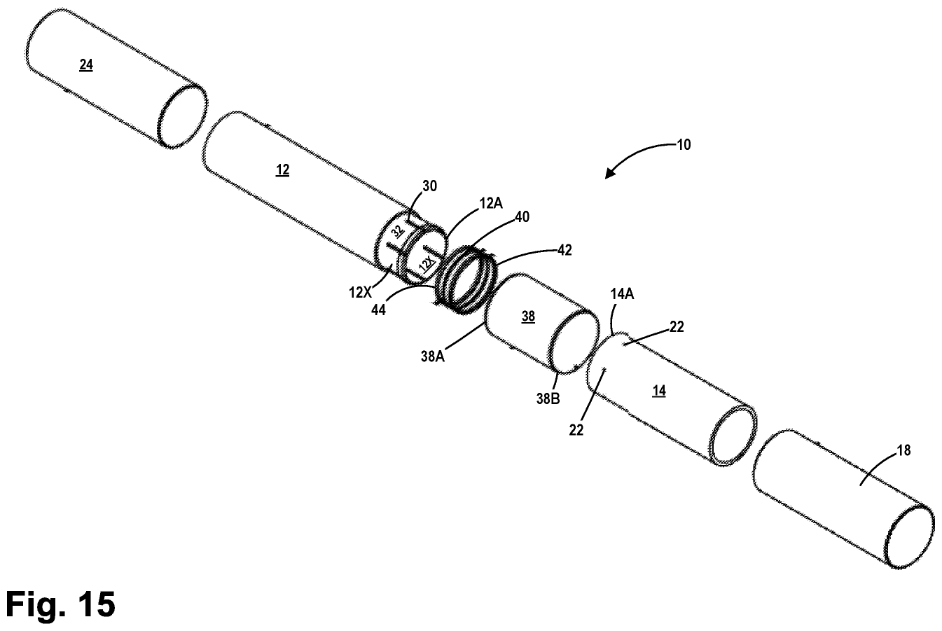

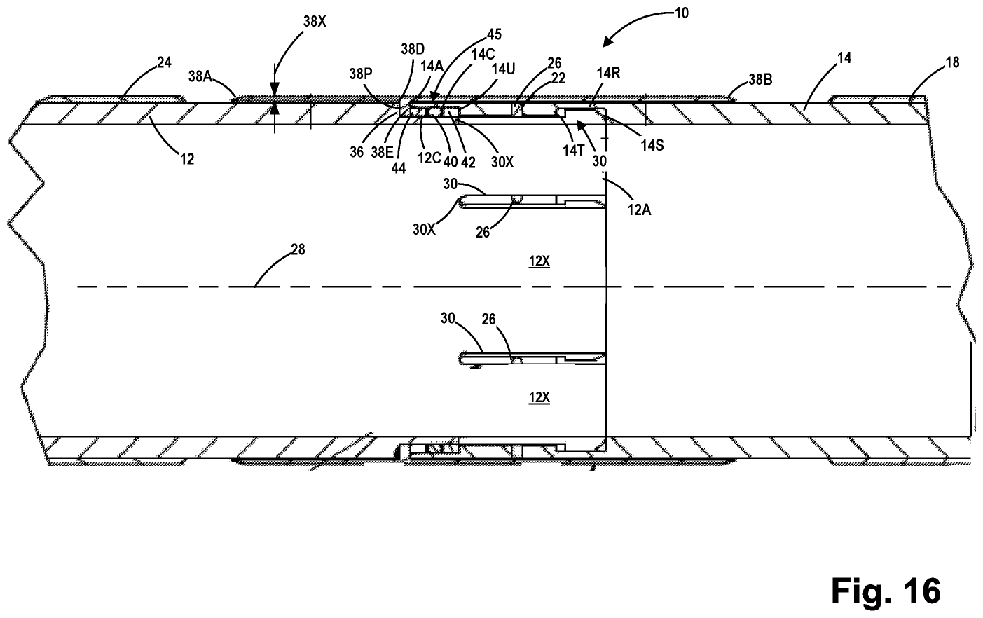

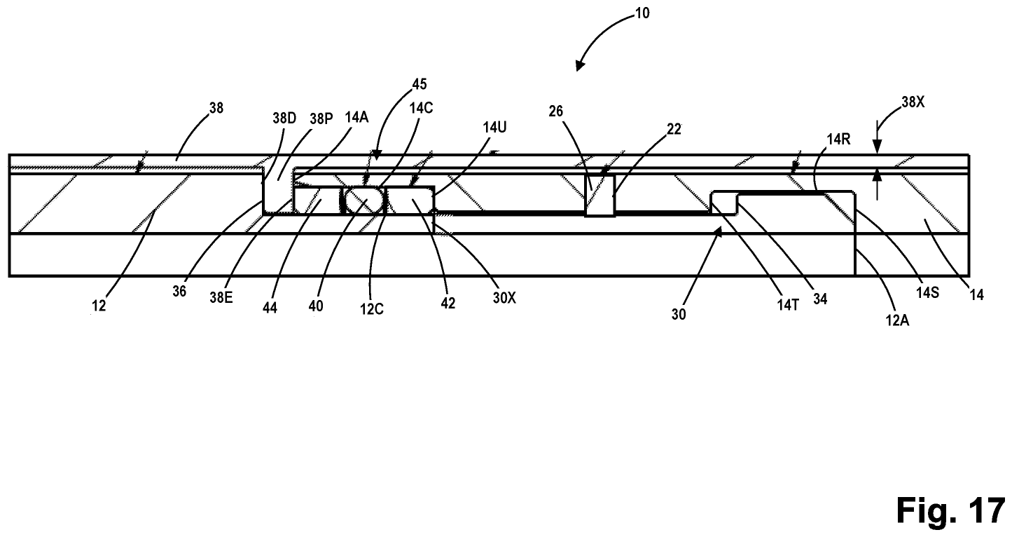

FIGS. 15-20 depict yet another illustrative novel embodiment of an expandable connection 10 for coupling expandable tubulars to one another. This embodiment is substantially the same as the one discussed above in connection with FIGS. 8-14 except that this embodiment includes a pressure-retaining seal 40 that is adapted to prevent fluid from leaking between the inside and outside of the engaged tubulars 12, 14 before, during and after the radial expansion of the tubulars 12, 14. The seal 40 may take a variety of forms, such as an O-ring or a D-seal. In the particular example shown in FIGS. 15-20, the pressure-retaining seal 40 takes the form of an O-ring that is positioned between a back-up ring 42 and a back-up ring 44. The back-up rings 42, 44 may not be employed in all applications, e.g., in the case where the pressure-retaining seal 40 is a D-seal, the back-up rings 42, 44 may be omitted. A perspective view of this embodiment when assembled would be substantially the same as that shown in FIG. 8. FIG. 15 is an exploded, perspective view of this illustrative embodiment of the connection 10. FIG. 16 is a cross-sectional view of this embodiment of the connection 10 taken along the axial centerline 28 of the connection 10, the first tubular 12 and the second tubular 14 when assembled before the first tubular 12 and second tubular 14 have been expanded. The view in FIG. 16 is also taken through the kerfs 30 formed on the first tubular 12. As before, the relative relationship between and among the connection 10, the first tubular 12 and the second tubular 14 depicted in FIG. 12 will remain substantially the same before and after expansion of the first tubular 12 and the second tubular 14, with the understanding that the components will undergo outward radial expansion. FIG. 17 is an enlarged cross-sectional view of the connection 10 between the first tubular 12 and the second tubular 14.

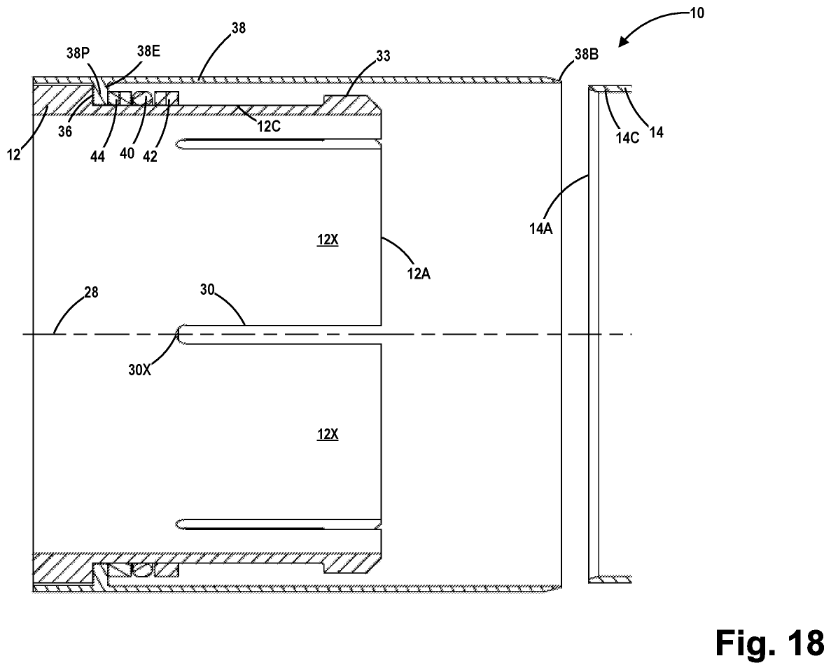

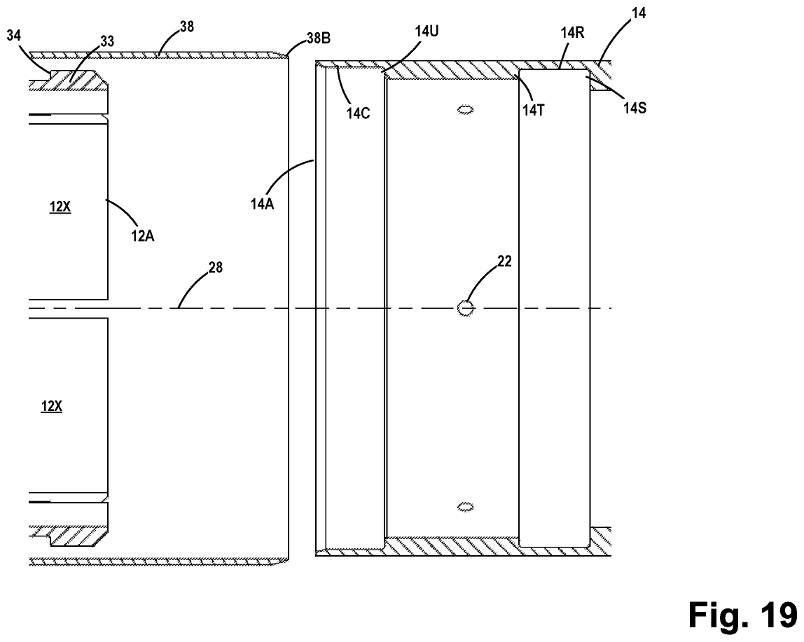

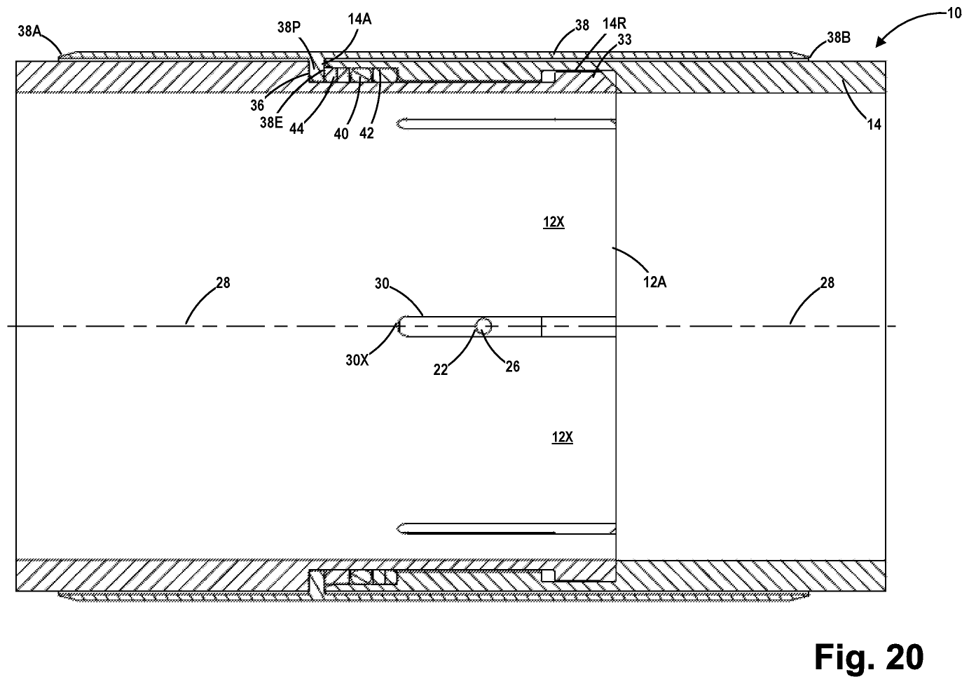

FIGS. 18 and 19 are exploded, cross-sectional views of the connection 10 before the tubulars 12, 14 are mated to one another. FIG. 20 is a cross-sectional view of the tubulars shown in FIGS. 18 and 19 after they have been coupled to one another. Various aspects of this illustrative example of the connection 10 between the first tubular 12 and 14 will be discussed more fully below.

As shown in FIGS. 15-20, this illustrative example of the expandable connection 10 is also adapted to couple the first tubular 12 and the second tubular 14 to one another. With specific reference to FIGS. 16-20, the combination of the seal 40, the back-up ring 42 and the back-up ring 44 are positioned in a cavity 45. The cavity 45 is defined in the axial direction by a substantially vertically oriented shoulder 14U on the second tubular 14 and a substantially vertically oriented shoulder 38E on the inwardly-extending protrusion 38P of the protective ring 38. The cavity 45 is defined in the radial direction by the surface 12C on the first tubular 12 and the surface 14C on the second tubular 14. As before, as shown in FIG. 5, each of the fingers 12X comprises the above-described groove 32 and an outwardly-extending protrusion 33. As before, the second tubular 14 comprises a shoulder 14S, a shoulder 14T and a groove 14R.

In terms of assembly of this embodiment, in one illustrative example, the elastomer bands 18, 24 may be glued or vulcanized to their respective tubulars. Thereafter, the protective ring 38 may be positioned on the first tubular 12 such that the rear shoulder 36 on the first tubular 12 engages the substantially vertically oriented rear shoulder 38D on the protrusion 38P of the protective ring 38. At that point, the back-up ring 44, the seal 40 and the back-up ring 42 may be sequentially positioned on the first tubular 12. Note that the back-up ring 44 engages the substantially vertically oriented forward shoulder 38E of the protrusion 38P of the protective ring 38. At that point, the second tubular 14 may be inserted through the second end 38B of the protective ring 38. As with the previous embodiment, the kerfs 30 on the first tubular 12 permit the fingers 12X to deflect radially inward toward the centerline 28 as the second tubular 14 engages the first tubular 12 The insertion of the second tubular 14 into the combination of the protective ring 38 and the first tubular 12 continues until such time as the protrusion 33 on each of the radially-deflectable fingers 12X on the first tubular 12 aligns with the groove 14R in the second tubular 14, at which time the protrusions 33 effectively spring outwardly, i.e., away from the centerline 28 into engagement with the groove 14R. At that time, the substantially vertically oriented forward shoulder 38E on the protrusion 38P of the protective ring 38 will also engage the first end 14A of the second tubular 14, thereby securing the protective ring 38 in position and securing the back-up ring 44, the seal 40 and the back-up ring 42 in the cavity 45. At that point, the threaded anti-rotation pins 26 (if present) may be installed in the threaded pin openings 22 prior to or after joint assembly to thereby prevent relative rotation between the first tubular 12 and the second tubular 14, as discussed above with respect to the previous embodiment. In this case, if the anti-rotation pins 26 are installed after the joint is assembled, openings (not shown) may be provided in the protective ring 38 to allow insertion of the anti-rotation pins 26 through the openings in the protective ring 38. As before, this process is repeated as many time as desired so as to create an overall string of expandable tubulars of a desired overall length. Thereafter, the assembly may be positioned in a well and radially expanded.

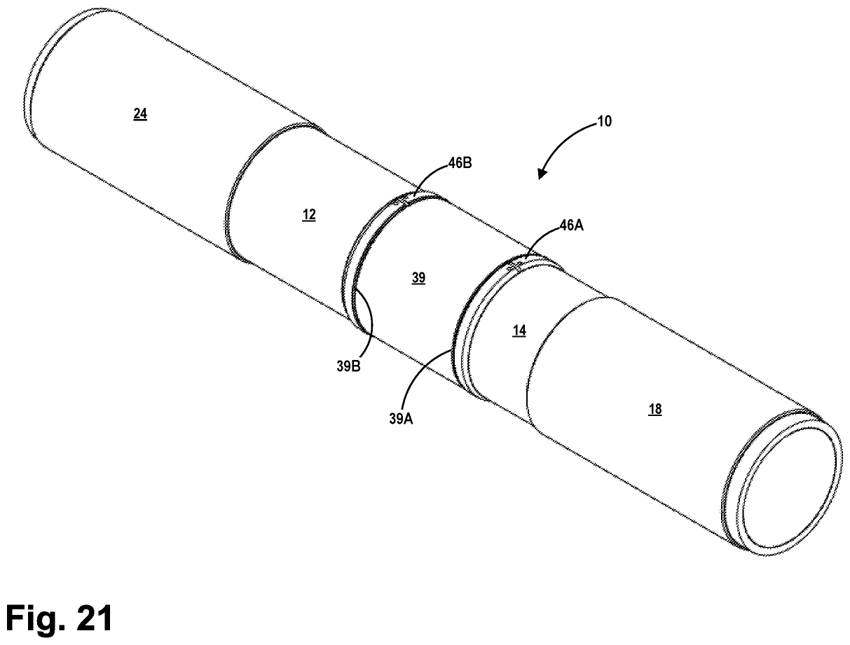

FIGS. 21-30 depict yet another illustrative novel embodiment of an expandable connection 10 for coupling expandable tubulars to one another. However, in this illustrative embodiment, the kerfs 30 are formed in the second tubular 14 so as to form a plurality of radially-deflectable fingers 14X adjacent a first end 14A of the second tubular 14.

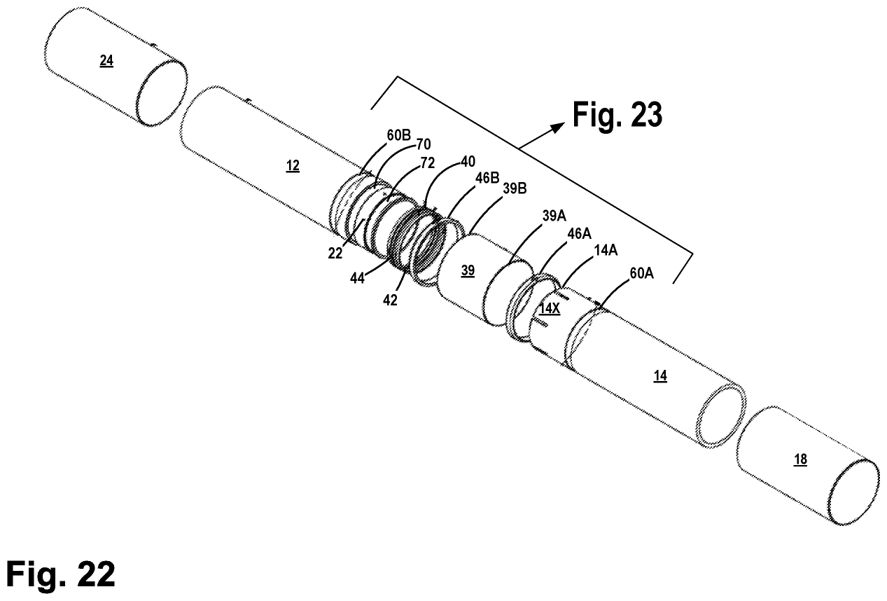

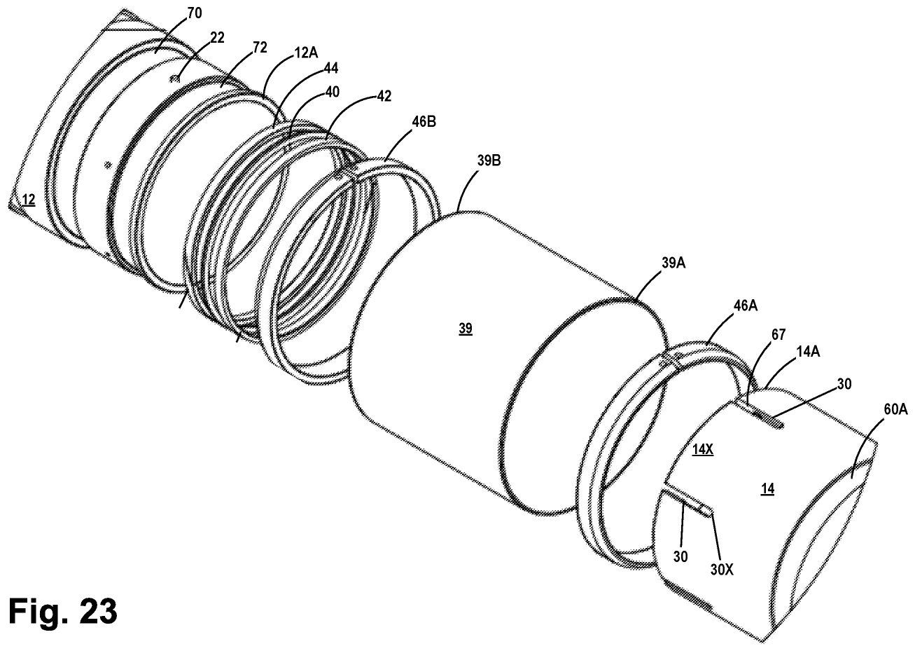

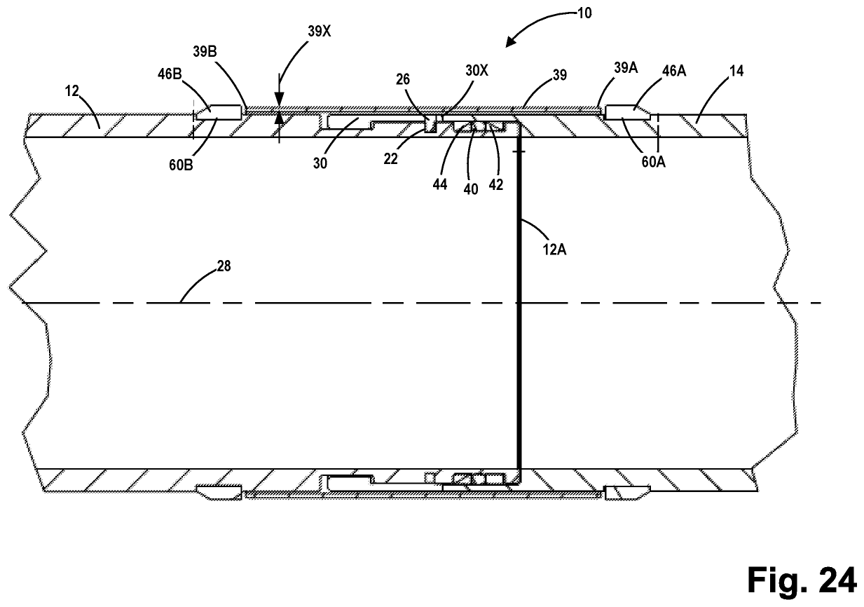

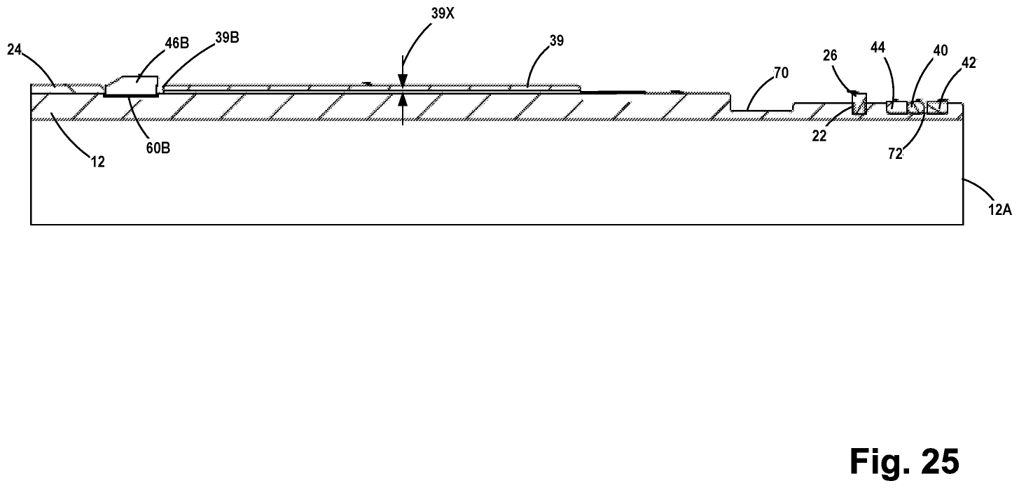

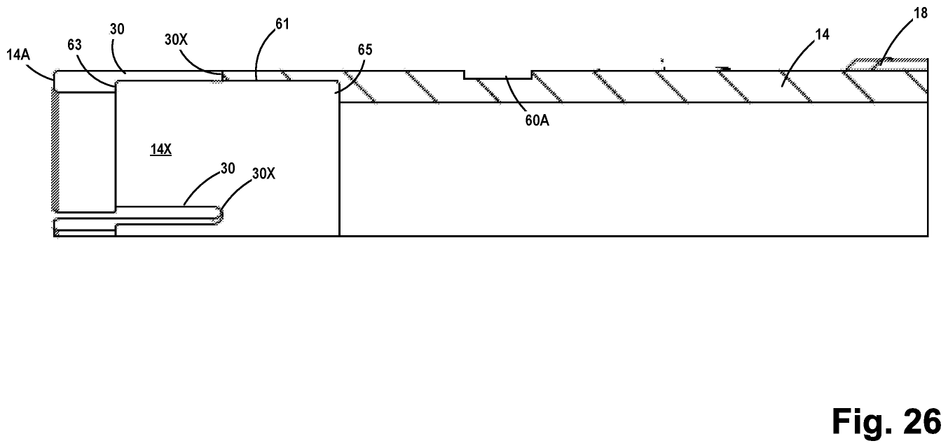

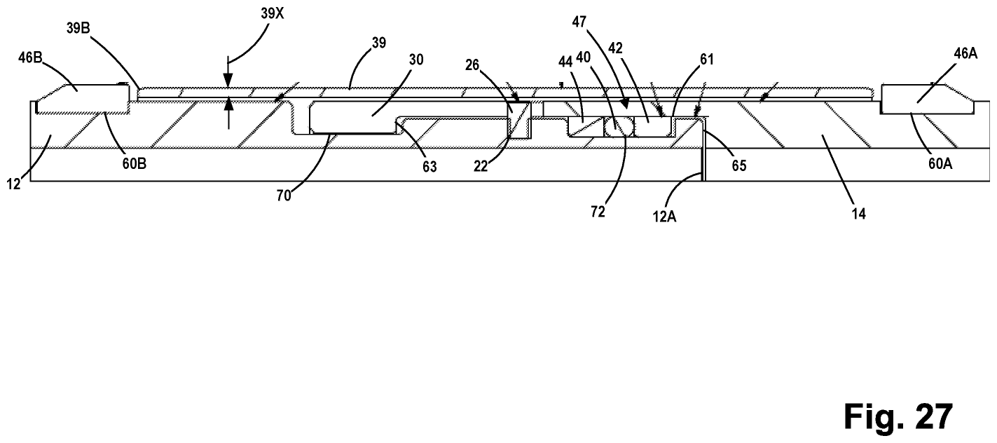

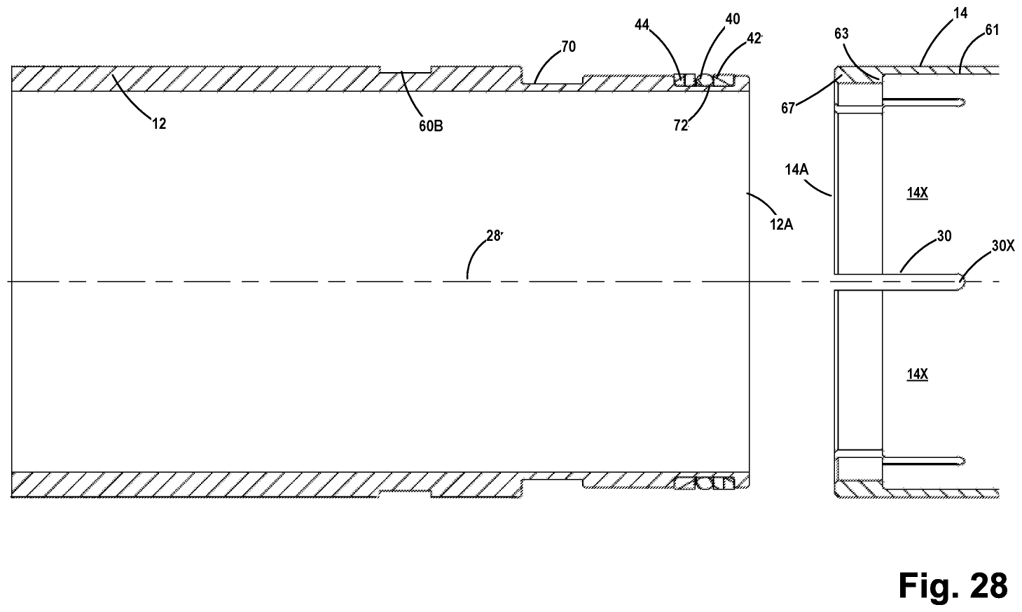

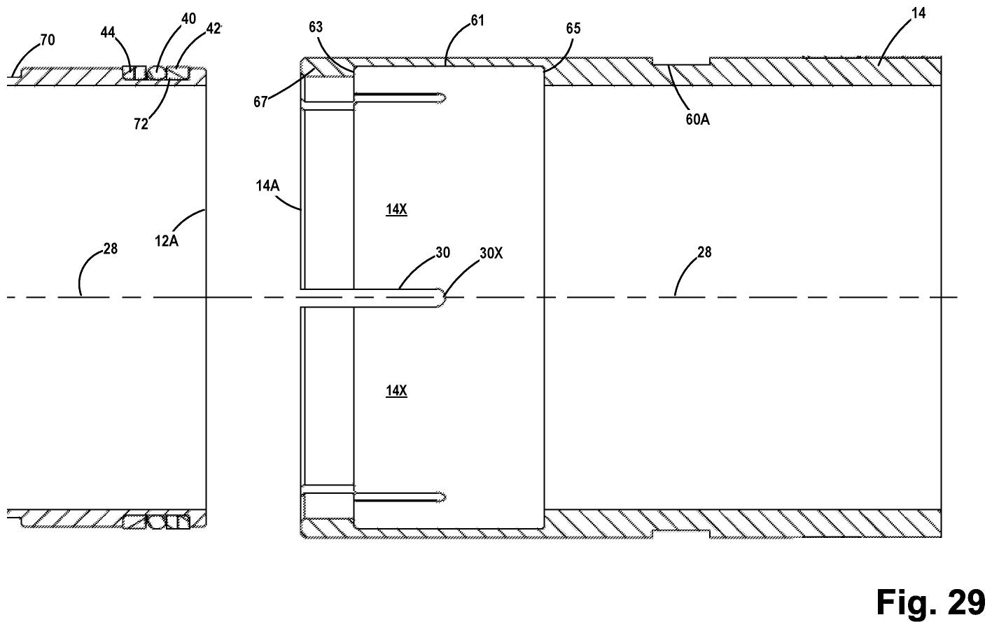

Additionally, in this embodiment, the connection 10 comprises a locking ring assembly that includes a locking ring 39 and first and second C-rings 46A, 46B that are adapted to be used to secure the locking ring 39 in position around the tubulars 12, 14. The above-described pressure-retaining seal 40 (in the form of an illustrative O-ring) and back-up rings 42, 44 are also included in this embodiment. FIG. 21 is a perspective view of this embodiment when assembled. FIG. 22 is an exploded, perspective view of this illustrative embodiment of the connection 10. FIG. 23 is an enlarged portion of the perspective view shown in FIG. 22. FIG. 24 is a cross-sectional view of this embodiment of the connection 10 taken along the axial centerline 28 of the connection 10, the first tubular 12 and the second tubular 14 after the tubulars 12, 14 have been assembled but prior to the tubulars 12, 14 being expanded. The view in FIG. 24 is also taken through the kerfs 30 that are formed on the second tubular 14. As before, the relative relationship between and among the connection 10, the first tubular 12 and the second tubular 14 depicted in FIGS. 24, 27 and 30 will remain substantially the same before, during and after expansion of the first tubular 12 and the second tubular 14, with the understanding that the components will undergo outward radial expansion. FIG. 25 is an enlarged cross-sectional view of the first tubular 12. FIG. 26 is an enlarged cross-sectional view of the second tubular 14 that is taken through one of the kerfs 30. FIG. 27 is an enlarged cross-sectional view of the connection 10 between the first tubular 12 and the second tubular 14 after the tubulars 12, 14 have been coupled to one another. FIGS. 28 and 29 are exploded, cross-sectional views of the connection 10 before the tubulars 12, 14 are mated to one another.

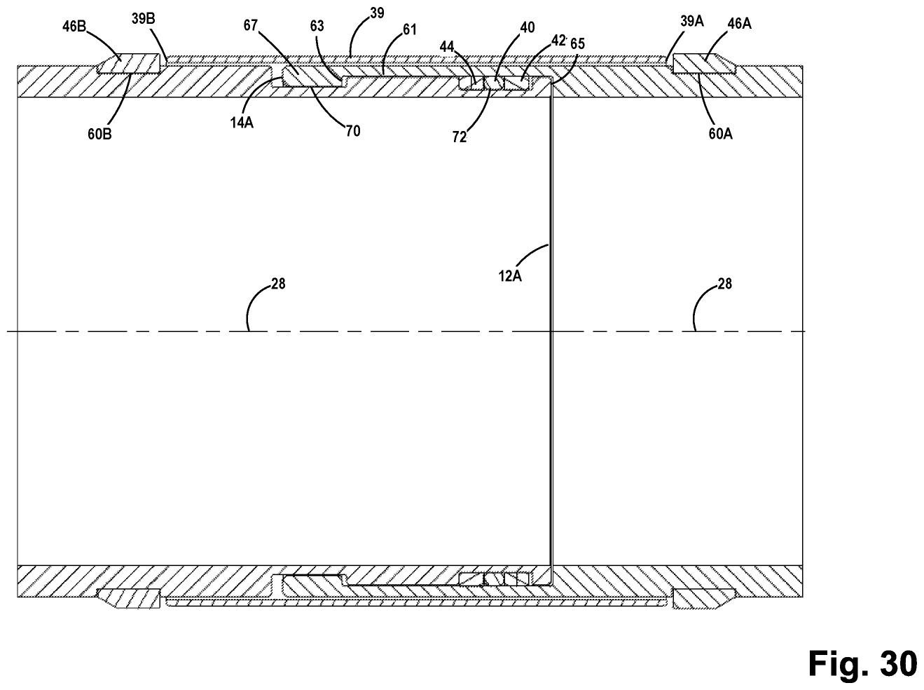

FIG. 30 is a cross-sectional view of the tubulars shown in FIGS. 28 and 29 after they have been coupled to one another. Various aspects of this illustrative example of the connection 10 between the first tubular 12 and the second tubular 14 will be discussed more fully below.

As shown in FIGS. 21-30, this illustrative example of the expandable connection 10 is also adapted to couple the first tubular 12 and the second tubular 14 to one another. As noted above, in this embodiment, the kerfs 30 are formed in the second (female) tubular 14. Each pair of adjacent kerfs 30 define a radially-deflectable finger 14X proximate the first end 14A of the second tubular 14. Each finger 14X comprises a groove 61 that is defined by a front shoulder 63 and a rear shoulder 65 and an inwardly-extending protrusion 67 between the front shoulder 63 and the first end 14A. In this embodiment, the first tubular 12 includes a groove 70, the threaded pin opening 22 and a seal groove 72. In the depicted example, the protrusion 67 on each of the radially-deflectable fingers 14X is adapted to be positioned in the groove 70 on the first tubular 12. In this particular example, the seal 40 comprises the illustrative back-up rings 42, 44 and the O-ring seal 40, all of which are collectively positioned in the seal groove 72. The locking ring 39 comprises a first end 39A and a second end 39B. In this example, the locking ring 39 is a cylindrical body that has a nominal radial thickness 39X (which may vary depending upon the particular application). The C-rings 46A, 46B are adapted to be positioned in grooves 60A, 60B, respectively, that are formed in the outer surfaces of the tubulars 14 and 12, respectively. With specific reference to FIG. 27, the combination of the seal 40, the back-up ring 42 and the back-up ring 44 are positioned in a cavity 47. The cavity 47 is defined by the combination of the groove 61 on the second tubular 14 and the seal groove 72 on the first tubular 12.

In terms of assembly of this embodiment, in one illustrative example, the elastomer bands 18, 24 may be glued or vulcanized to their respective tubulars. The C-rings 46A, 46B may be positioned on their respective tubulars 14, 12 but not within their corresponding grooves 60A, 60B. At that point, the locking ring 39 may be positioned on the first tubular 12 above its final installed position and temporarily secured in that position. Thereafter, in this illustrative embodiment, one or more of the anti-rotation pins 26 may be screwed into the threaded pin opening 22 in the first tubular 12. Then, the combination of the seal 40 and the back-up rings 42, 44 are positioned in the seal groove 72 on the first tubular 12.

Thereafter, the tubulars 12, 14 may be urged into mating engagement with one another. During this mating process, the radially-deflectable fingers 14X deflect radially outward, i.e., away from the centerline 28. The mating of the tubulars 12, 14 continues until such time as the inwardly-extending protrusion 67 on each of the radially-deflectable fingers 14X on the second tubular 14 aligns with the groove 70 in the first tubular 12, at which time the protrusions 67 effectively spring inwardly into engagement with the groove 70. Next, the locking ring 39 may be positioned around the mated tubulars 12, 14 and the C-rings 46A, 46B may be installed in the grooves 60A, 60B, respectively, to secure the locking ring 39 in position. Note that, the locking ring 39 may still be allowed to move a limited amount axially along the assembled tubulars 12, 14 between the C-rings 46A, 46B. As before, this process is repeated as many times as desired so as to create an overall string of expandable tubulars of a desired overall length. At that point, the overall string of connected expandable tubulars are adapted to be positioned in a cased well or an open borehole and thereafter radially expanded, wherein, in this embodiment, the locking ring 39 will also be radially expanded such that its expanded inside diameter will be greater than its initial (pre-expansion) inside diameter.

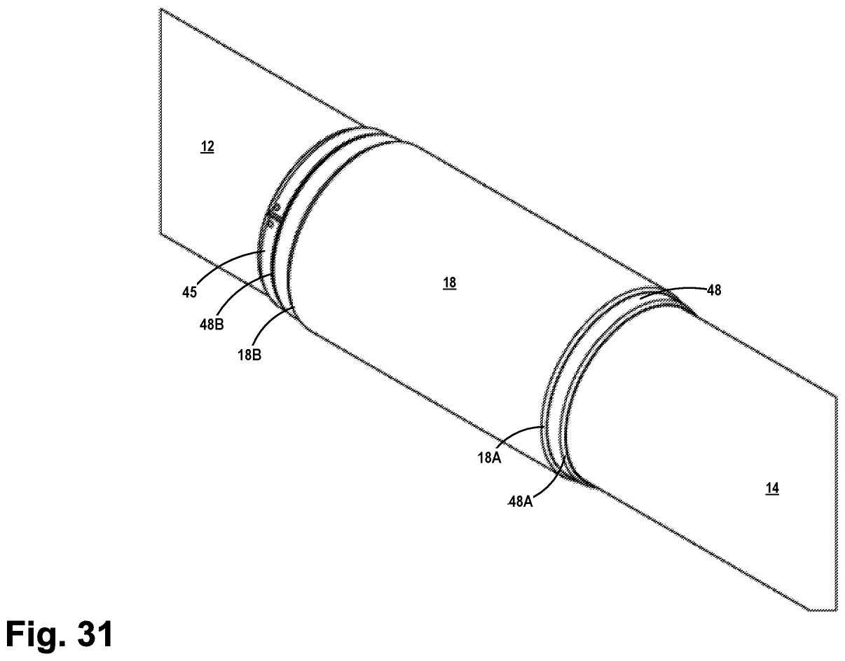

FIGS. 31-37 depict yet another illustrative novel embodiment of an expandable connection 10 for coupling expandable tubulars to one another. This embodiment is similar to the one discussed above in connection with FIGS. 21-30 except that, in this embodiment, the illustrative seal 40 (in the form of an O-ring seal), the back-up ring 42 and the back-up ring 44 have been omitted and replaced with a pressure-retaining seal 50 in the form of an illustrative D-seal. Additionally, in this embodiment, only a single C-ring 46 is used to secure the locking ring 39 in position around the mated tubulars 12, 14. In this embodiment, the kerfs 30 are formed in the second tubular 14 so as to thereby form the radially-deflectable fingers 14X in the second tubular 14.

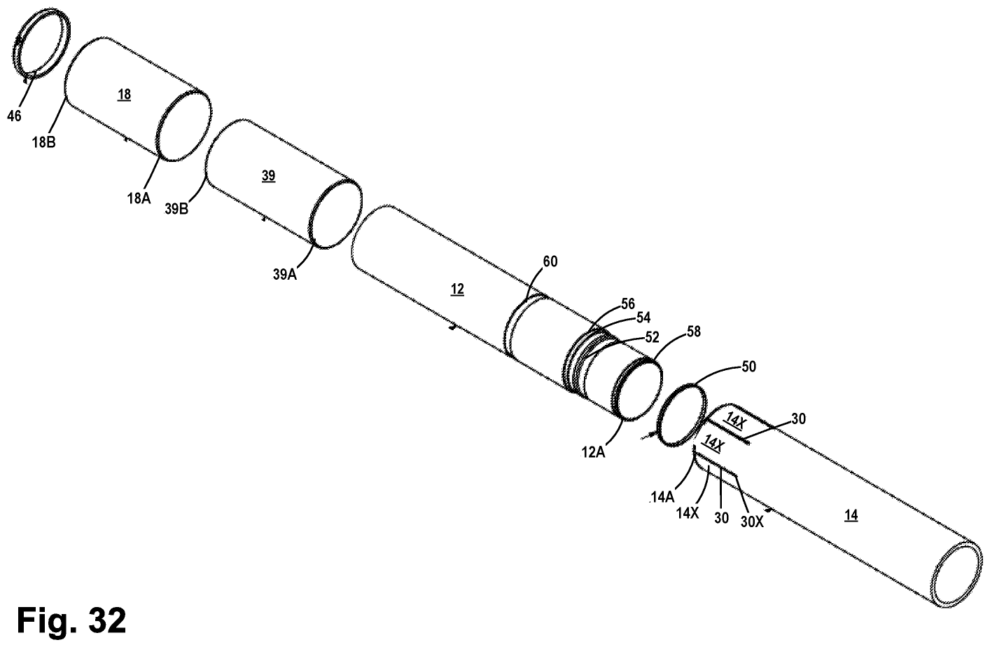

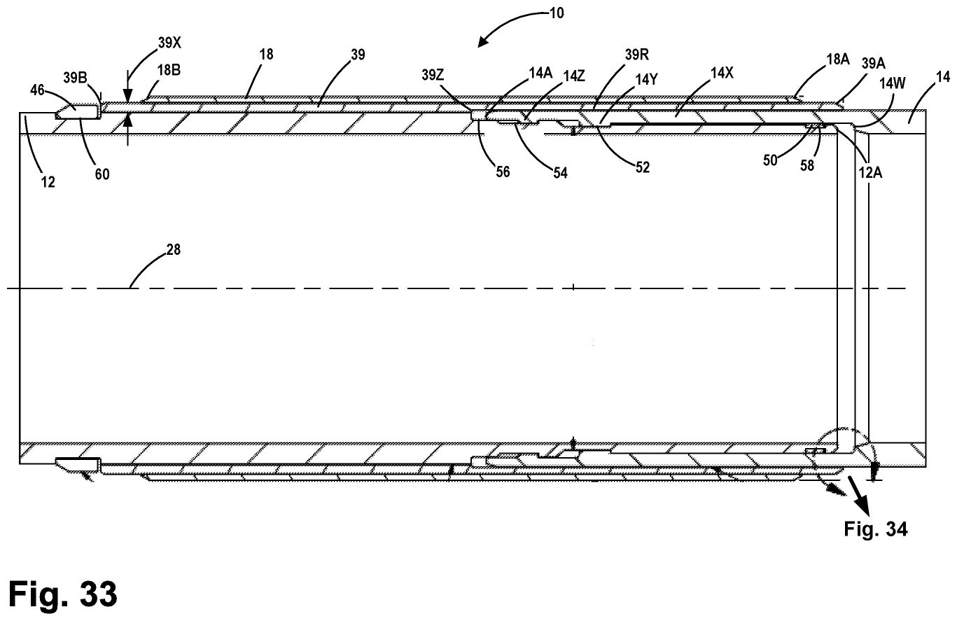

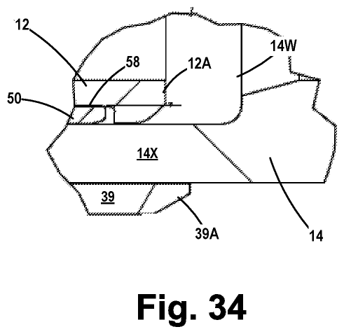

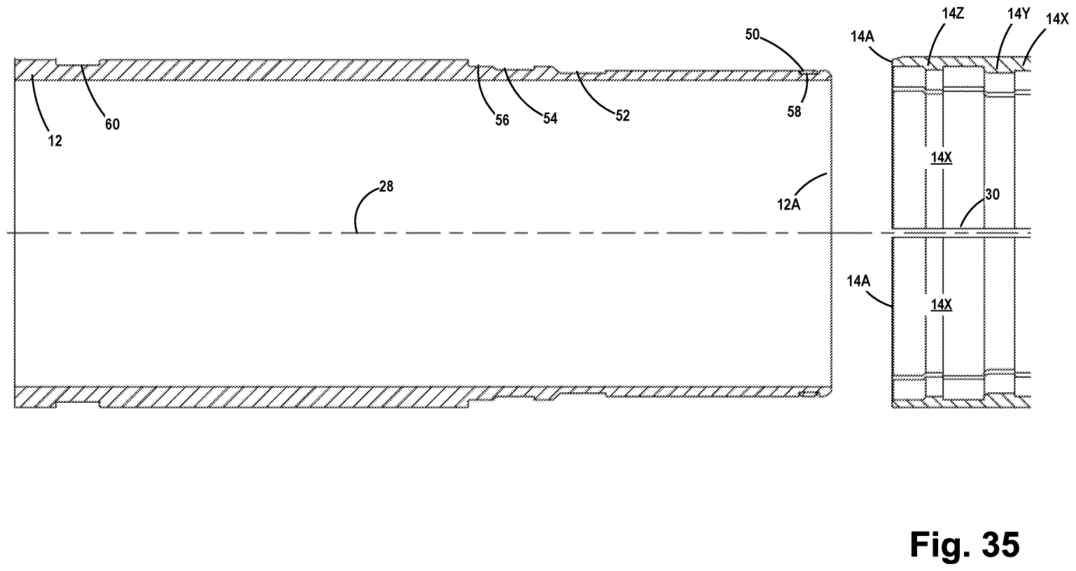

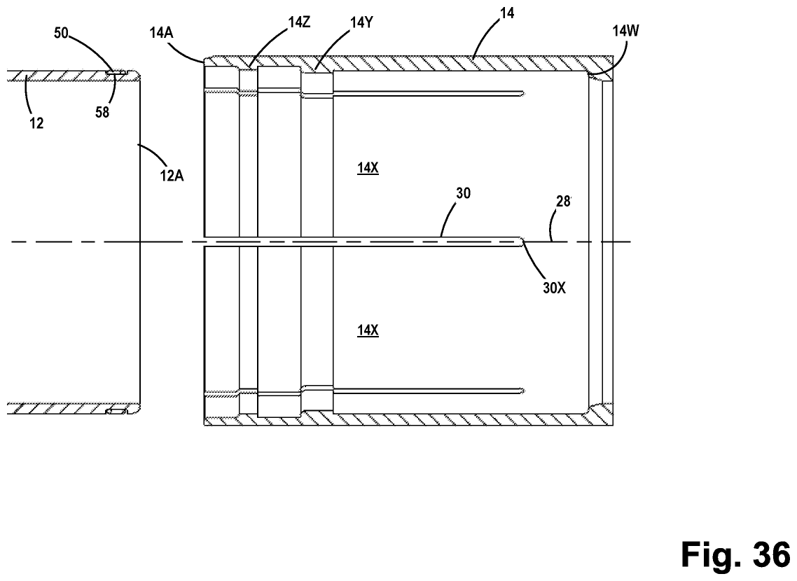

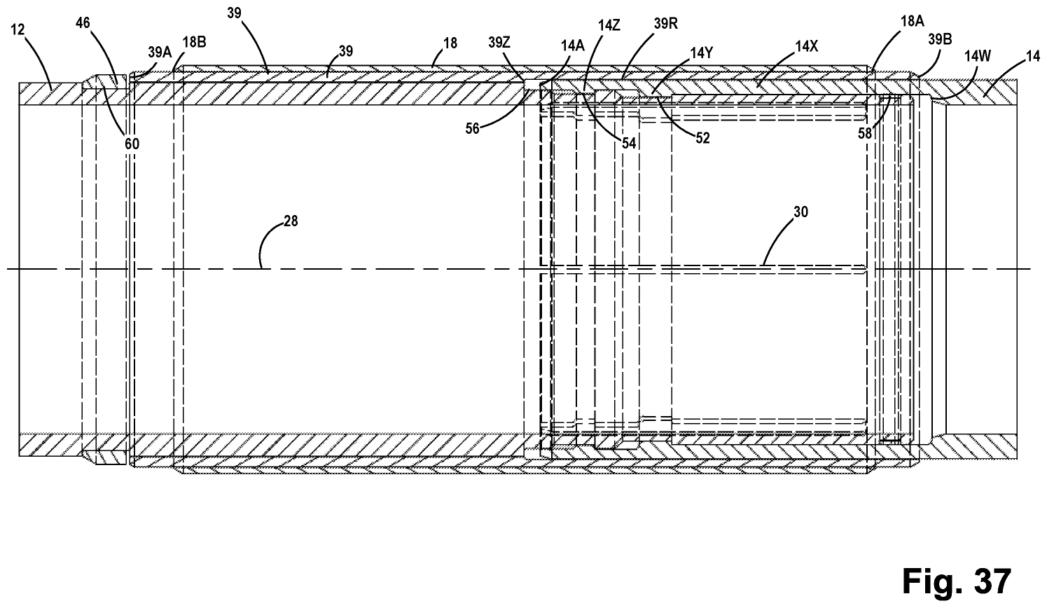

FIG. 31 is a perspective view of this embodiment when assembled and prior to insertion into a well. FIG. 32 is an exploded, perspective view of this illustrative embodiment of the connection 10. FIG. 33 is a cross-sectional view of this embodiment of the connection 10 taken along the axial centerline 28 of the connection 10, the first tubular 12 and the second tubular 14 when assembled and before the first tubular 12 and the second tubular 14 have been expanded. FIG. 34 is a drawing depicting a particular sealing detail of this illustrative embodiment. FIGS. 35 and 36 are exploded, cross-sectional views of the connection 10 before the tubulars 12, 14 are mated to one another. FIG. 37 is a cross-sectional view of the tubulars shown in FIGS. 35 and 36 after they have been coupled to one another. As before, the relative relationship between and among the connection 10, the first tubular 12 and the second tubular 14 depicted in FIGS. 33-37 will remain substantially the same before, during and after expansion of the first tubular 12 and the second tubular 14, with the understanding that the components will undergo outward radial expansion. Various aspects of this illustrative example of the connection 10 between the first tubular 12 and the second tubular 14 will be discussed more fully below.

As shown in FIGS. 31-37, this illustrative example of the expandable connection 10 is also adapted to couple the first tubular 12 and the second tubular 14 to one another. As shown in these drawings, the locking ring 39 has a body with a first end 39A and a second end 39B. The locking ring 39 has a nominal radial thickness 39X which may vary depending upon the particular application. Similarly, the elastomer band 18 comprises a first end 18A and a second end 18B. A groove 60 formed in the outer surface of the first tubular 12 is adapted to receive the C-ring 46. The first tubular 12 also includes a groove 52, a groove 54, a groove 56 and a seal groove 58. The grooves 52, 54 and 56 are successively shallower in depth. This embodiment of the connection 10 also includes a pressure-retaining seal 50 to prevent fluid from leaking between the inside and outside of the engaged tubulars 12, 14 before, during and after the process of radially expanding the tubulars 12, 14. The pressure-retaining seal 50 make take a variety of forms. In this particular example, the pressure-retaining seal 50 takes the form of an illustrative D-seal that is adapted to be positioned in the seal groove 58. As noted above, in this embodiment, the kerfs 30 are formed in the second (female) tubular 14 whereby each pair of adjacent kerfs 30 define a radially-deflectable finger 14X proximate the first end 14A of the second tubular 14. Each finger 14X comprises first inwardly-extending protrusion 14Y and a second inwardly-extending protrusion 14Z. The first protrusion 14Y is adapted to be positioned in the groove 52. The second protrusion 14Z is adapted to be positioned in the groove 54. The groove 56 is adapted to receive the front end 14A of the second tubular 14. A shoulder 14W is also provided on the second tubular 14.

In terms of assembly of this embodiment, in one illustrative example, any elastomer bands that are positioned on the tubulars 12, 14 are attached to the tubulars by gluing them in position or by vulcanization. The C-ring 46 may then be positioned on the first tubular 12 but not within the groove 60. At that point, the locking ring 39 may be positioned on the first tubular 12 above its final installed position and temporarily secured in that position. Next, the pressure-retaining seal 50 may be positioned in the seal groove 58. Thereafter, the tubulars 12, 14 may be urged into mating engagement with one another. During this mating process, the radially-deflectable fingers 14X deflect radially outward, i.e., away from the centerline 28. The mating of the tubulars 12, 14 continues until such time as the inwardly-extending protrusions 14Y, 14Z on each of the fingers 14X on the second tubular 14 aligns with the grooves 52, 54, respectively, in the first tubular 12, at which time the protrusions 14Y, 14Z effectively spring inwardly into engagement with the grooves 52, 54, respectively. At that time, the front end 14A of the fingers 14X will be positioned in the groove 56. At that point, the locking ring 39 may be positioned around the mated tubulars 12, 14 at a point of connection between the mated tubulars 12, 14. Note that the locking ring 39 includes a recess 39R that has a diameter that is slightly larger than the outer diameter of the first tubular 12. The recess 39R is adapted to receive a portion of the radial thickness of each of the radially-deflectable fingers 14X. After the locking ring 39 is positioned around the mated tubulars, the C-ring 46 may be installed in the groove 60 to secure the locking ring 39 in position. Note that the locking ring 39 may still be allowed to move a limited amount axially along the assembled tubulars 12, 14, i.e., axial movement of the locking ring 39 may be limited in a first direction by the engagement between the second end 39B of the locking ring 39 and the C-ring 46 and in a second direction by engagement between the front end 14A of the fingers 14X and the edge 39Z of the recess 39R formed in the locking ring 39.

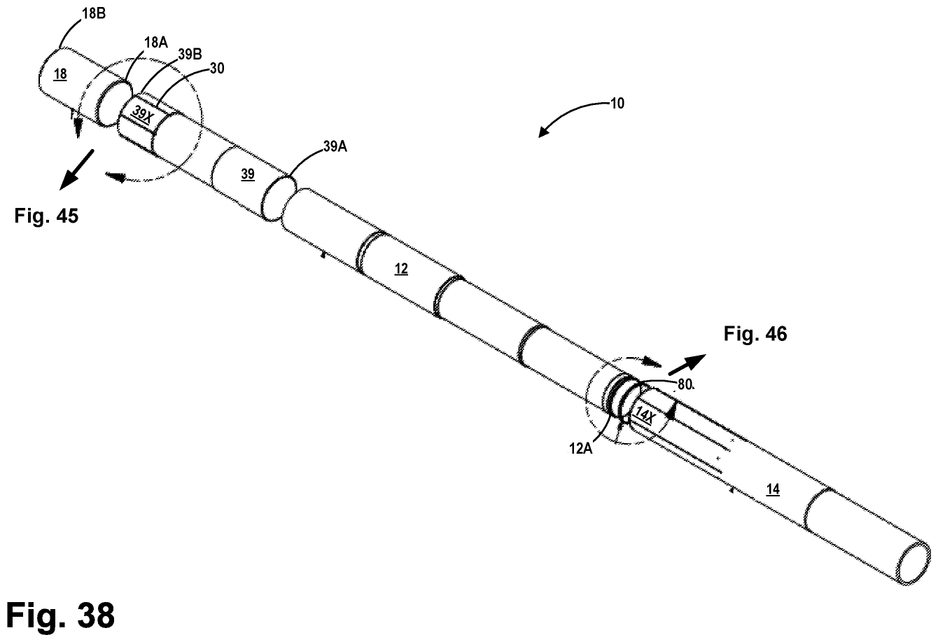

FIGS. 38-51 depict yet another illustrative novel embodiment of an expandable connection 10 for coupling expandable tubulars to one another. However, this embodiment of the connection 10 is unique from the previous embodiments in that it is specifically designed for applications where the assembled and expanded tubulars 12, 14 may be expected to experience appreciable thermal expansion in the axial direction during operation in the well after the expanded tubulars 12, 14 are installed in the well. In the previous embodiments, once the tubulars 12, 14 were mated together, relative axial movement between the tubulars 12, 14 was prevented (subject to manufacturing tolerances of course) due to the engagement of the protrusion on the radially-deflectable fingers (12X or 14X as the case may be) with a groove in the other tubular. In this embodiment, each of the tubulars 12, 14 is provided with an axially elongated groove that is adapted to receive a protrusion formed on the opposite tubular. These elongated grooves permit axial movement of the protrusion on the opposing tubular that is positioned within the axially elongated groove, as described more fully below.

In this illustrative example, as with some of the previous embodiments, a plurality of kerfs 30 are formed in the second tubular 14 (the box) so as to form the radially-deflectable fingers 14X. Of course, in other applications, the kerf 30 could be formed on the first tubular 12 (the pin), but this embodiment is not depicted in the drawings. Relative to the previous embodiments of the connection discussed above, the radially-deflectable fingers 14X on this embodiment of the connection may have a significantly greater axial length.

This embodiment of the connection 10 also includes a pressure-retaining seal 80 to prevent fluid from leaking between the inside and outside of the engaged tubulars 12, 14 before, during and after the process of radially expanding the tubulars 12, 14. The first tubular 12 comprises a seal groove 97 that is adapted to receive the seal 80. The pressure-retaining seal 80 make take a variety of forms. In this particular example, the pressure-retaining seal 80 takes the form of an illustrative D-seal.

Additionally, in this embodiment, a plurality of kerfs 30 are formed in the locking ring 39 so as to form a plurality or radially-deflectable fingers 39X on the locking ring 39. Each of the radially-deflectable fingers 39X includes an inwardly-extending protrusion 39P adjacent the end 39B of the locking ring 39. As described more fully below, each of the radially-deflectable fingers 39X are adapted to be deflected radially-outward during the process of installing the locking ring 39.

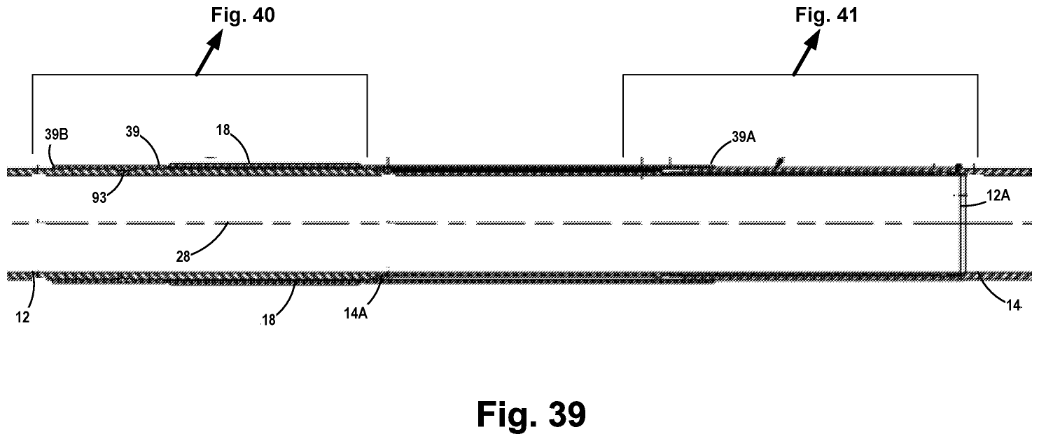

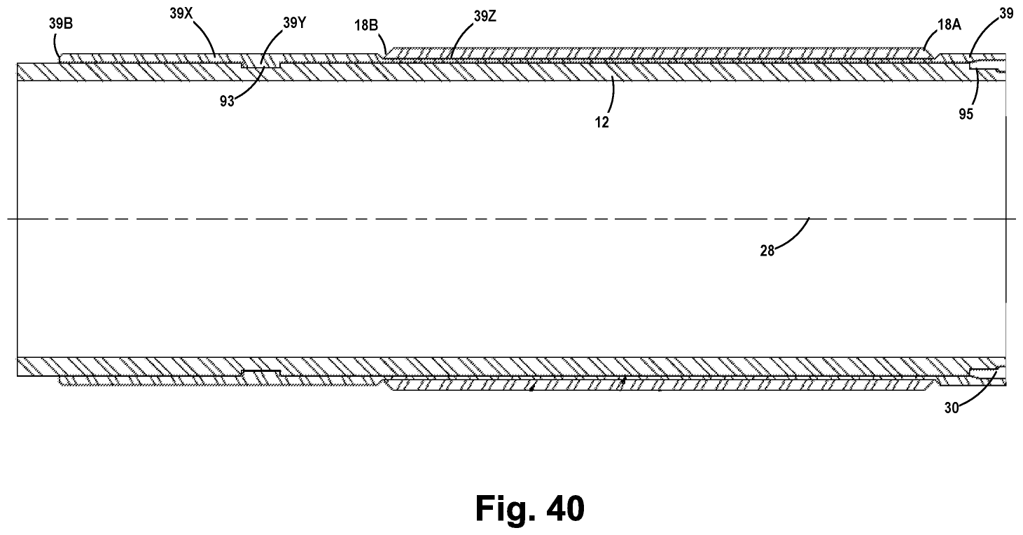

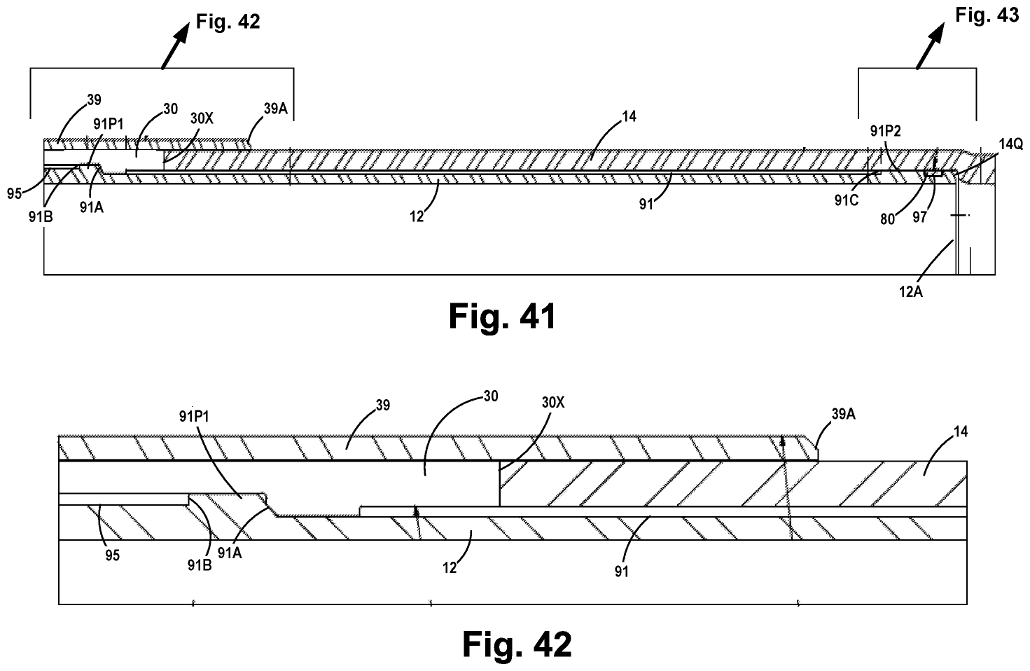

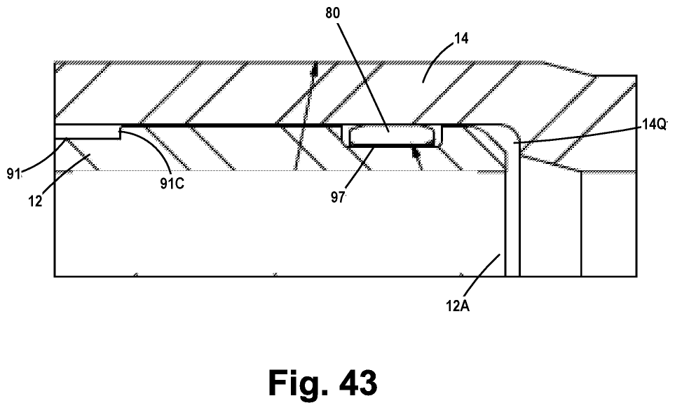

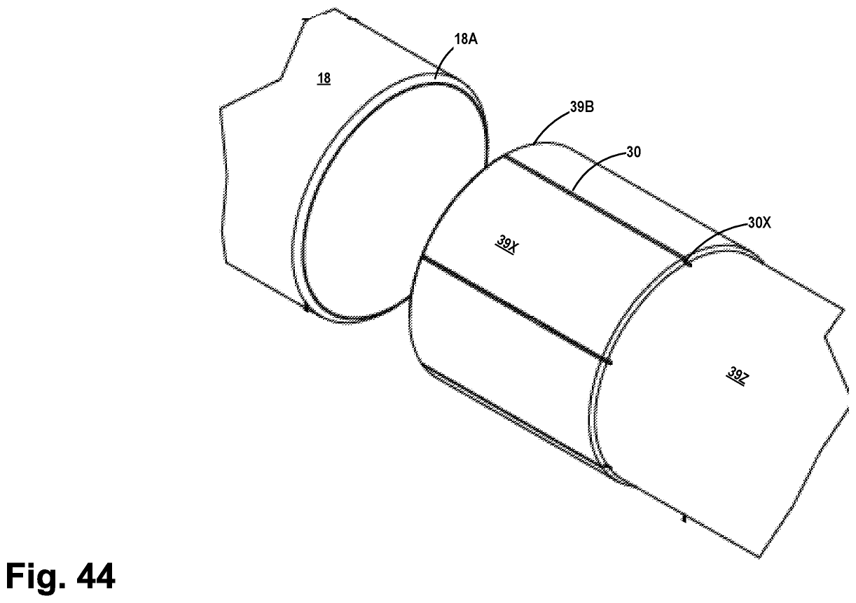

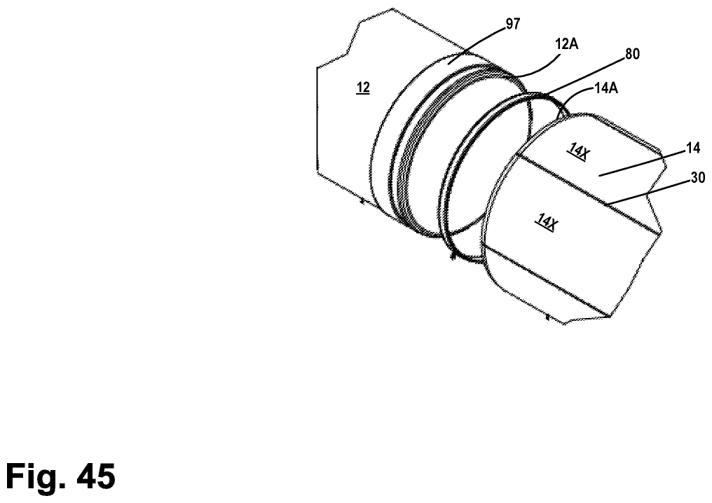

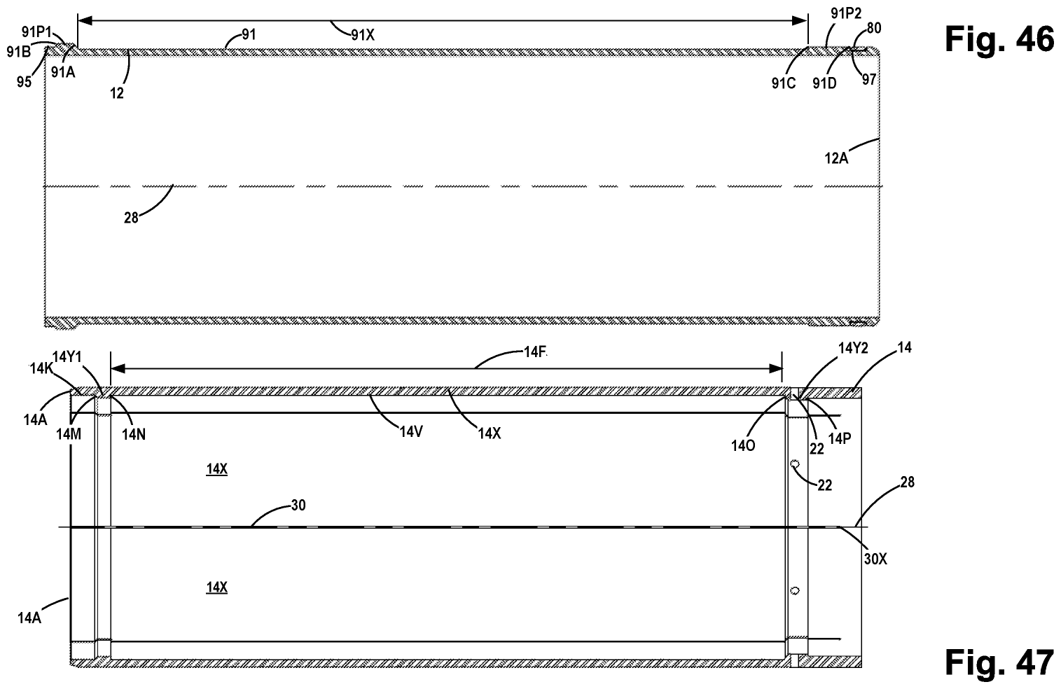

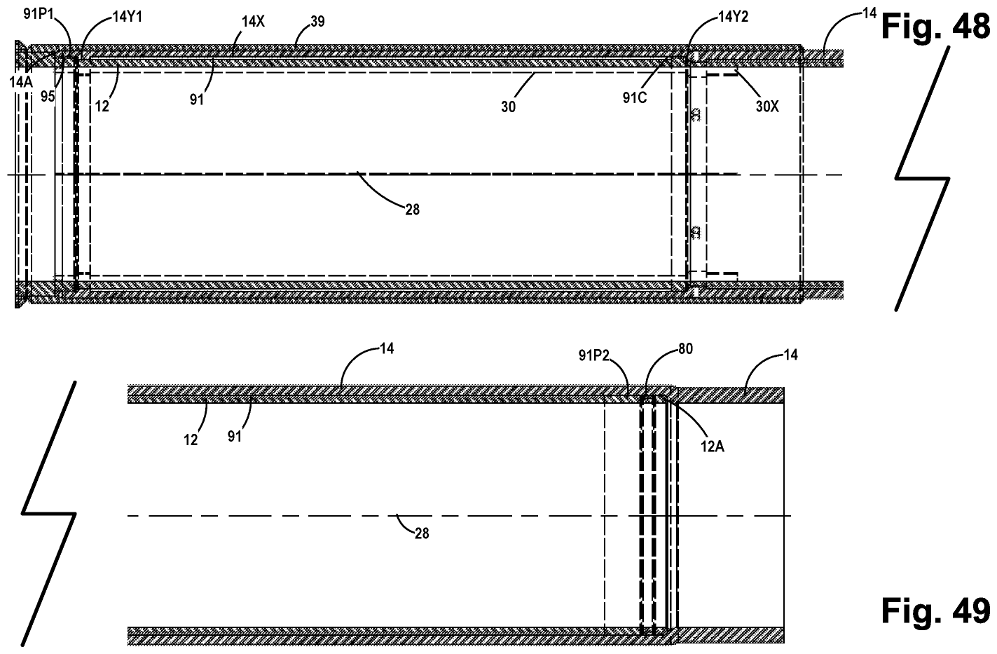

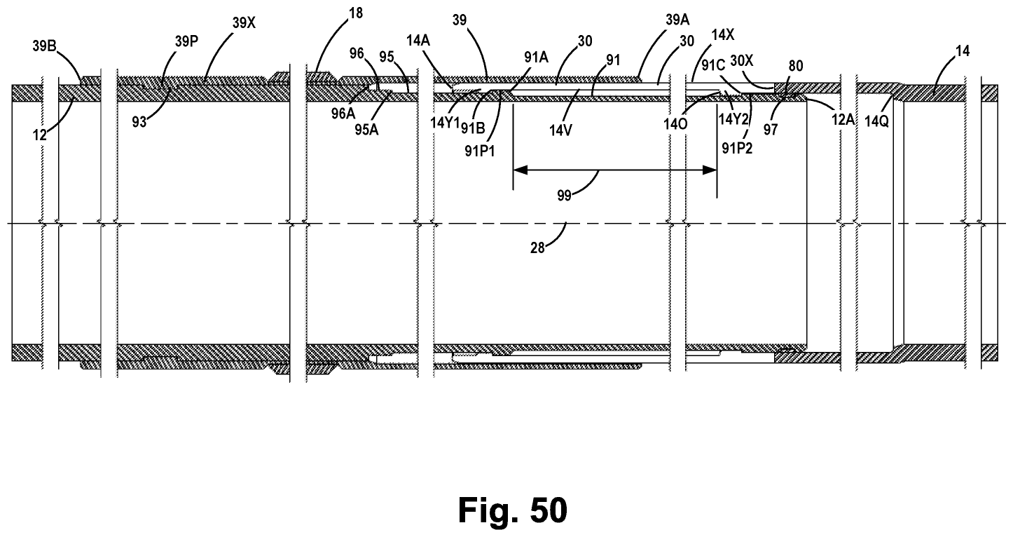

FIG. 38 is an exploded, perspective view of this illustrative embodiment of the connection 10. FIG. 39 is a cross-sectional view of this embodiment of the connection 10 taken along the axial centerline 28 of the connection 10, the first tubular 12 and the second tubular 14. FIG. 40 is a cross-sectional view that depicts, among other things, the engagement between the radially-deflectable fingers 39X on the locking ring 39 and a groove 93 in the outer surface of the first tubular 12. FIG. 41 is an enlarged cross-sectional view that depicts, among other things, a portion of the assembled tubulars 12, 14 in one possible configuration wherein the assembled tubulars are run into the well. The view in FIG. 41 is also taken through the kerfs 30 formed on the second tubular 14. FIG. 42 is an enlarged view of a portion of FIG. 41. FIG. 43 is an enlarged cross-sectional view of the tubulars 12, 14 showing the position of the pressure-retaining seal 80 in the seal groove 97. FIG. 44 is an exploded perspective view of a portion of the illustrative locking ring 39 disclosed in this illustrative example of the connection 10. FIG. 45 is an exploded perspective view of a portion of the illustrative tubulars 12, 14 as well as the illustrative sealing ring 80. FIG. 46 is a cross-sectional view of a portion of the first tubular 12 in this illustrative embodiment. FIG. 47 is a cross-sectional view of a portion of the second tubular 14 in this illustrative embodiment. In combination, FIGS. 48 and 49 depict the connection in an assembled configuration wherein the tubulars 12, 14 are coupled to one another and the locking ring 39 is coupled to the first tubular 12.

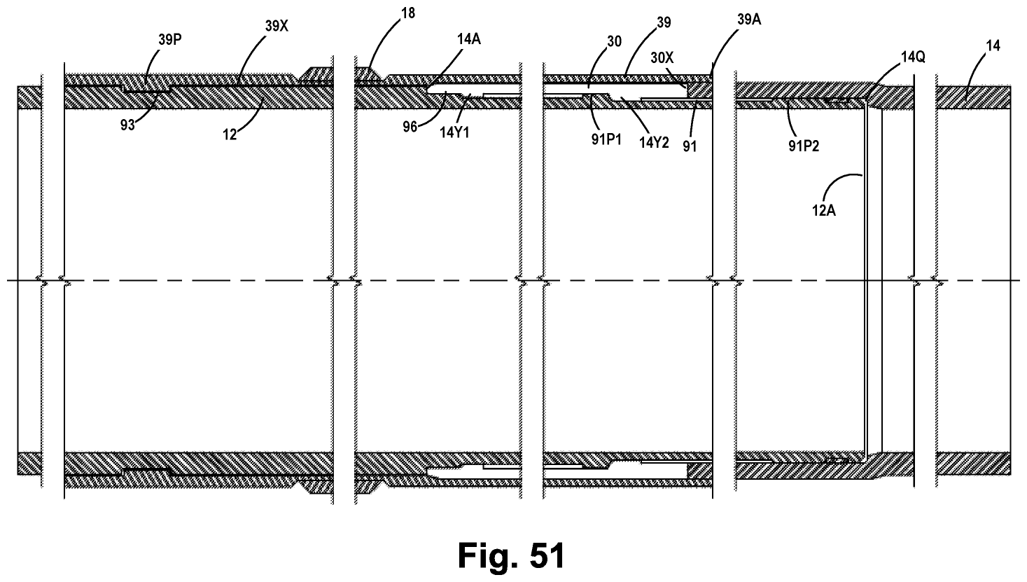

FIG. 50 depicts one illustrative embodiment of the assembled tubulars 12, 14 after they have been positioned in the well and radially expanded and prior to the tubulars 12, 14 experiencing any appreciable thermal expansion. FIG. 51 depicts one illustrative embodiment of the assembled tubulars 12, 14 after they have been positioned in the well and radially expanded and after the tubulars 12, 14 have undergone maximum thermal expansion due to downhole operating temperatures. Various aspects of this illustrative example of the connection 10 between the first tubular 12 and the second tubular 14 will be discussed more fully below.

The first tubular 12 further comprises a groove 91, a groove 93, a groove 95 and a groove 96. As described more fully below, during the installation of the locking ring 39, the radially-deflectable fingers 39X of the locking ring 39 will be deflected radially outward, i.e., away from the centerline 28 until such time as the locking ring 39 is moved to a point where the inwardly-extending protrusion 39P on each of the radially-deflectable fingers 39X on the locking ring 39 aligns with the groove 93 in the first tubular 12, at which time the protrusions 39P effectively spring inwardly into engagement with the groove 93 on the first tubular 12. In one illustrative embodiment, the axial length of the locking ring 39 is sufficient to cover the entire axial length of the kerfs 30 in the second tubular 14 when the overall axial length of the assembled tubulars 12, 14 is at a maximum.

With reference to FIG. 46, the elongated groove 91 in the first tubular 12 is defined (in an axial direction) by a first outwardly-extending protrusion 91P1 (with side surfaces 91A and 91B) and a second outwardly-extending protrusion 91P2 (with side surfaces 91C and 91D). The elongated groove 91 has an axial length 91X between the surfaces 91A and 91C (see FIG. 46). The magnitude of the axial length 91X may vary depending upon the particular application. With reference to FIG. 50, the groove 95 is defined (in the axial direction) by the side surface 91B of the first outwardly-extending protrusion 91P1 and a side surface 95A. With reference to FIG. 50, the groove 96 comprises a side surface 96A.

With reference to FIG. 47, each of the radially-deflectable fingers 14X comprises an elongated internal groove 14V that is defined (in an axial direction) by a first inwardly-extending protrusion 14Y1 (with side surfaces 14M and 14N) and a second inwardly-extending protrusion 14Y2 (with side surfaces 14O and 14P). The elongated internal groove 14V has an axial length 14F between the surface 14N and the surface 14O. The magnitude of the axial length 14F may vary depending upon the particular application.

When the tubulars are assembled, i.e., operatively coupled to one another, various protrusions on a tubular are positioned in various grooves on the mating tubular. More specifically, the groove 95 on the first tubular 12 is adapted to receive the first inwardly-extending protrusion 14Y1 of the radially-deflectable fingers 14X. The groove 91 on the first tubular 12 is adapted to receive the second inwardly-extending protrusion 14Y2 of the radially-deflectable fingers 14X. The groove 14V on the second tubular 14 is adapted to receive the first outwardly-extending protrusion 91P1 of the first tubular 12. The groove 96 on the first tubular 12 is adapted to receive a portion of the fingers 14X that extends from the surface 14M of the protrusion 14Y1 to the end surface 14A of the second tubular 14.

As described more fully below, the outwardly-extending protrusion 91P1 on the first tubular 12 is allowed to move axially within the groove 14V between the inwardly-extending protrusions 14Y1 and 14Y2. The inwardly-extending protrusions 14Y1 on the radially-deflectable fingers 14X are allowed to move axially within the groove 95. With reference to FIG. 50, in the depicted example, the maximum amount of relative movement between the assembled tubulars 12, 14, i.e., the available thermal expansion length, is the distance 99 between the side surface 91A of the first outwardly-extending protrusion 91P1 on the first tubular 12 and the side surface 14O on the second inwardly-extending protrusion 14Y2 of the radially-deflectable fingers 14X. In one illustrative example, the axial length of the grooves 95 and 91 may be approximately the same, with the connection designed in a manner such that, when the tubulars 12, 14 are in their maximum extended length, the seal 80 remains engaged with an inner surface on the second tubular 14. As noted above, the absolute values of the lengths 91X and 14F of the grooves 91 and 14V, respectively, may vary depending upon the particular application and the anticipated thermal cycles the expanded tubulars will experience during operations. In general, the lengths 91X and 14F of the grooves 91 and 14V, respectively, may be multiple times the axial length of the protrusions on the mating tubular that are allowed to move axially within the grooves 91 and 14V.

Relative downward and upward movement of the tubulars 12, 14 may be limited by engagement of various surfaces on each of the tubulars 12, 14. The exact surfaces that are selected for limiting such relative travel between the tubulars 12, 14 upon engagement of such surfaces may vary as a matter of design choice. For example, in one embodiment, downward relative movement between the tubulars 12, 14 may be stopped when the end surface 12A of the first tubular 12 engages the internal shoulder 14Q on the second tubular 14. In other embodiments, downward relative movement between the tubulars 12, 14 may be stopped when the side surface 91A of the protrusion 91P1 engages the side surface 14O of the protrusion 14Y2. Similarly, in one embodiment, upward relative movement between the tubulars 12, 14 may be stopped when the end surface 14A of the second tubular 14 engages the side surface 96A of the groove 96 in the second tubular 14. In yet other embodiments, upward relative movement between the tubulars 12, 14 may be stopped when the side surface 14M of the protrusion 14Y1 engages the side surface 95A of the groove 95.

In one illustrative embodiment, when the assembled tubulars 12, 14 are axially compressed to their shortest overall combined axial length, the side surface 14M of the first inwardly-extending protrusion 14Y1 will engage the side surface 95A of the groove 95. In this axially compressed position, the portion of the radially-deflectable fingers 14X from the side surface 14M to the end 14A will be positioned in the groove 96, e.g., the end 14A of the second tubular 14 may engage the side surface 96A of the groove 96. Additionally, when the assembled tubulars 12, 14 are axially compressed to their shortest overall axial length, the end surface 12A of the first tubular 12 may engage the shoulder 14Q on the second tubular 14.

In one illustrative embodiment, when the assembled tubulars 12, 14 are axially extended to their greatest overall combined axial length, the side surface 91A of the first outwardly-extending protrusion 91P1 will engage the side surface 14O of the second inwardly-extending protrusion 14Y2 of the radially-deflectable fingers 14X. In this axially extended position, the side surface 14N of the first inwardly-extending protrusion 14Y1 may engage the side surface 91B of the first outwardly-extending protrusion 91P1.

In terms of assembly of this embodiment, in one illustrative example, any elastomer bands that are positioned on the tubulars 12, 14 or the locking ring 39 are initially attached to the tubulars 12, 14 and the locking ring 39 by gluing them in position or by vulcanization. At that point, the locking ring 39 may be positioned on the first tubular 12 above its final installed position and temporarily secured in that position. In this initial position, the radially-deflectable fingers 39X of the locking ring 39 are deflected radially outward and the protrusion 39P on the finger 39X has not yet engaged the groove 93 on the first tubular 12. Next, the pressure-retaining seal 80 may be positioned in the seal groove 97. Thereafter, the tubulars 12, 14 may be urged into mating engagement with one another. During this mating process, the radially-deflectable fingers 14X deflect radially outward. The mating of the tubulars 12, 14 continues until such time as the inwardly-extending protrusions 14Y1, 14Y2 on each of the radially-deflectable fingers 14X on the second tubular 14 aligns with the grooves 95, 91, respectively, in the first tubular 12, at which time the protrusions 14Y1, 14Y2 effectively spring inwardly into engagement with the grooves 95, 91, respectively. At that point, the locking ring 39 may be moved toward the area of connection between the mated tubulars 12, 14. Movement of the locking ring 39 continues until such time as the protrusions 39P on the fingers 39X snap into engagement with the groove 93 on the first tubular 12.

With respect to installation of the assembled tubulars 12, 14 in the well, one illustrative technique would involve the following. At the surface, the tubulars 12, 14 are assembled such that the end surface 12A of the first tubular 12 is positioned adjacent or abutting the shoulder 14Q on the second tubular 14, as shown in FIGS. 41 and 51. At that point, the combined assembly is run into the well to the desired location within the well where the tubulars 12, 14 will be radially expanded. Based upon the anticipated thermal loading conditions during operating conditions, the sizes of the various grooves and protrusions on the tubulars are sized to provide the desired amount of length 99 that is available for thermal expansion. The actual length 99 available for thermal expansion designed into the connection will likely be greater than the actual anticipated thermal expansion so as to provide a margin of error with respect to setting the initial relative position of the tubulars 12, 14 in the well prior to performing the expansion process.

Once the combined assembly has been positioned at the desired location within the well, the operator may urge the first tubular 12 further downward to insure or confirm that the end 12A of the first tubular 12 abuts the shoulder 14Q in the second tubular 14, i.e., to make sure that the first tubular 12 has bottomed out against the second tubular 14. In most applications, there should be sufficient frictional forces between the outside of the second tubular 14 and the inside of the well (i.e., the casing or the formation (in the case of an open wellbore)) to provide a sufficient reaction force to permit the tubular 12 to be moved relative to the tubular 14. At that point, and with reference to FIG. 50, the operator will move the first tubular 12 uphole until such time as the side surface 91B on the first outwardly-extending protrusion 91P1 engages the side surface 14N on the first inwardly-extending protrusion 14Y1 of the radially-deflectable fingers 14X. Note the separation between the end surface 12A and the shoulder 14Q of the second tubular 14. Engagement of these two surfaces sets the maximum available thermal expansion length for the combined assembly of the tubulars 12, 14. The engagement of these two surfaces may be detected at the surface by the additional weight of the string, i.e., the additional weight of the tubular 14 when these two surfaces are engaged. Thus, the relative position of the tubulars 12, 14 shown in FIG. 50 reflects the initial position of the tubulars 12, 14 prior to the expansion process, which will be approximately maintained as the tubulars 12 and 14 are radially expanded within the well. At that point, with the tubulars 12, 14 in the initially installed positon shown in FIG. 50, the tubulars 12 and 14 are radially expanded. FIG. 51 also depicts the expanded tubulars 12, 14 at a point during well operations wherein the first tubular 12 has undergone the maximum possible thermal expansion, i.e., the end surface 12A abuts the shoulder 14Q. In practice, the connection will normally be designed such that, even under the greatest amount of anticipated thermal expansion, the end surface 12A would still be axially spaced apart from the shoulder 14Q.

As will be appreciated by those skilled in the art after a complete reading of the present application, various novel devices and methods are disclosed herein with respect to the connection 10 described immediately above. For example, one illustrative apparatus disclosed herein includes a first tubular 12 that is mated to a second tubular 14, wherein, when mated, the first and second tubulars are intentionally permitted to move axially relative to one another (by an amount that is more than would be allowed by mere manufacturing tolerances). In this example, the mated first and second tubulars are adapted to be radially expanded such that, after the radial expansion, the expanded mated first and second tubulars have an expanded inside diameter that is greater than an initial inside diameter of the mated first and second tubulars. In this example, the apparatus also includes a plurality of kerfs in an end of one of the first and second tubulars, wherein the kerfs define a plurality of radially-deflectable fingers that are adapted to deflect radially when the first and second tubulars are mated together.

One illustrative method disclosed herein includes positioning a first tubular 12 adjacent a second tubular 14, wherein one of the first and second tubulars includes a plurality of radially-deflectable fingers formed in an end thereof and mating the first and second tubulars into mated engagement with one another and wherein, during the mating of the first and second tubulars, the radially-deflectable fingers deflect in a radial direction. In this example, when mated, the first and second tubulars are intentionally permitted to move axially relative to one another. The method further includes expanding the first and second tubulars by forcing an expansion mandrel through the mated first and second tubulars such that the expanded first and second tubulars have an expanded inside diameter that is greater than an initial inside diameter of the first and second tubulars.

Yet another illustrative method disclosed herein includes positioning a first tubular 12 adjacent a second tubular 14, wherein one of the first and second tubulars includes a plurality of radially-deflectable fingers formed in an end thereof, and mating the first and second tubulars into mated engagement with one another, wherein, during the mating of the first and second tubulars, the radially-deflectable fingers deflect in a radial direction and wherein, when mated, the first and second tubulars are permitted to move axially relative to one another. In this example, the method also includes positioning the mated first and second tubulars 12, 14 at a desired location within a well, wherein, at the desired location within the well, the first and second tubulars are in a first relative axial positon relative to one another (e.g., see FIG. 41 wherein the first end 12A of the first tubular 12 is positioned adjacent the shoulder 14Q in the second tubular 14). In this example, the method also includes moving at least one of the first and second tubulars so as to establish a second relative axial position between the first and second tubulars (e.g., see FIG. 50 wherein the first end 12A of the first tubular 12 is axially spaced apart from the shoulder 14Q in the second tubular 14) that is different from the first relative axial position. The method further includes, with the first and second tubulars in the second relative axial position (see, e.g., FIG. 50), expanding the first and second tubulars by forcing an expansion mandrel through the mated first and second tubulars such that the expanded first and second tubulars have an expanded inside diameter that is greater than an initial inside diameter of the first and second tubulars. As will be appreciated by those skilled in the art after a complete reading of the present application, with respect to identifying the first and second relative axial positions of the first and second tubulars 12, 14, such relative axial positions can be seen by referencing surfaces on the tubulars 12, 14 other than those mentioned immediately above. For example, the first relative axial position between the tubulars 12, 14 could equally be identified by engagement between the side surface 91B on the first outwardly-extending protrusion 91P1 with the surface 14O on the second inwardly-extending protrusion 14Y2 of the radially-deflectable fingers 14X (see, e.g., FIG. 51). Similarly, the second relative axial position between the tubulars 12, 14 could equally be identified by engagement of the side surface 91A on the first outwardly-extending protrusion 91P1 with the surface 14N on the first inwardly-extending protrusion 14Y1 of the radially-deflectable fingers 14X (see, e.g., FIG. 50).

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Note that the use of terms, such as “first,” “second,” “third” or “fourth” to describe various processes or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the claims below.

What is claimed:

1. A method, comprising:
positioning a first tubular adjacent a second tubular, each of the first and second tubulars having an initial inside diameter, one of the first and second tubulars comprising a plurality of radially-deflectable fingers formed in an end thereof;
mating the first and second tubulars into mated engagement with one another, wherein, during the mating of the first and second tubulars, the radially-deflectable fingers deflect in a radial direction; and
expanding the first and second tubulars by forcing an expansion mandrel through the mated first and second tubulars such that the expanded first and second tubulars have an expanded inside diameter that is greater than the initial inside diameter of the first and second tubulars.

2. The method of claim 1, wherein each of the plurality of radially-deflectable fingers is defined by first and second kerfs formed in the end of one of the first and second tubulars.

3. The method of claim 1, wherein the plurality of radially-deflectable fingers are formed on the first tubular and wherein mating the first and second tubulars into mated engagement with one another comprises positioning the plurality of radially-deflectable fingers with the second tubular, wherein, during the mating of the first and second tubulars, the radially-deflectable fingers deflect radially inward toward a centerline of the first tubular.

4. The method of claim 1, wherein the plurality of radially-deflectable fingers are formed on the second tubular and wherein mating the first and second tubulars into mated engagement with one another comprises positioning an end of the first tubular within the plurality of radially-deflectable fingers, wherein, during the mating of the first and second tubulars, the radially-deflectable fingers deflect radially outward away from a centerline of the second tubular.

5. The method of claim 1, wherein, after mating the first and second tubulars into mated engagement with one another, and prior to expanding the first and second tubulars, the method further comprises positioning a seal around the mated first and second tubulars at an area of engagement between the first and second tubulars.

6. The method of claim 1, wherein, after mating the first and second tubulars into mated engagement with one another, and prior to expanding the first and second tubulars, the method further comprises positioning a protective ring around the mated first and second tubulars at an area of engagement between the first and second tubulars.

7. The method of claim 6, wherein the protective ring has an initial inside diameter and wherein forcing the expansion mandrel through the first and second tubulars also radially expands the protective ring such that the expanded protective ring comprises an expanded inside diameter that is greater than the initial inside diameter of the protective ring.

8. The method of claim 1, wherein, after mating the first and second tubulars into mated engagement with one another, and prior to expanding the first and second tubulars, the method further comprises positioning a locking ring around the mated first and second tubulars at an area of engagement between the first and second tubulars.

9. The method of claim 8, wherein the locking ring has an initial inside diameter and wherein forcing the expansion mandrel through the first and second tubulars also radially expands the locking ring such that the expanded locking ring comprises an expanded inside diameter that is greater than the initial inside diameter of the protective ring.

10. The method of claim 8, further comprising, after positioning the locking ring around the mated first and second tubulars, the method further comprises positioning a first C-ring in a first groove formed in an outer surface of one of the first and second tubulars.

11. The method of claim 10, further comprising positioning a second C-ring in a second groove formed in an outer surface of the one of the first and second tubulars that does not comprise the first groove.

12. The method of claim 1, wherein, during the mating of the first and second tubulars into mated engagement with one another, one of the first and second tubulars remains stationary.

13. An apparatus, comprising:
a first tubular;
a second tubular mated to the first tubular, the first and second tubulars being made of a metal-containing material, wherein each of the first and second tubulars have an initial inside diameter and wherein the mated first and second tubulars are adapted to be radially expanded such that, after the radial expansion, the expanded first and second tubulars have an expanded inside diameter that is greater than the initial inside diameter of the first and second tubulars; and
a plurality of kerfs in an end of one of the first and second tubulars, wherein the kerfs define a plurality of radially-deflectable fingers that are adapted to deflect radially when the first and second tubulars are mated together.

14. The apparatus of claim 13, wherein the plurality of kerfs and the plurality of radially-deflectable fingers are formed on the first tubular, wherein the plurality of radially-deflectable fingers are positioned within the second tubular, and wherein the plurality of radially-deflectable fingers are adapted to deflect radially inward toward a centerline of the first tubular when the first and second tubulars are mated together.

15. The apparatus of claim 13, wherein the plurality of kerfs and the plurality of radially-deflectable fingers are formed on the second tubular, wherein an end of the first tubular is positioned within the plurality of radially-deflectable fingers, and wherein the plurality of radially-deflectable fingers are adapted to deflect radially outward away from a centerline of the second tubular when the first and second tubulars are mated together.

16. The apparatus of claim 13, further comprising a seal positioned around the first and second tubulars at an area of engagement between the mated first and second tubulars.

17. The apparatus of claim 13, further comprising a protective ring positioned around the mated first and second tubulars at an area of engagement between the mated first and second tubulars.

18. The apparatus of claim 13, further comprising a locking ring positioned around the mated first and second tubulars at an area of engagement between the mated first and second tubulars.

19. The apparatus of claim 18, further comprising a first C-ring positioned in a first groove formed in an outer surface of one of the first and second tubulars.

20. The apparatus of claim 19, further comprising a second C-ring positioned in a second groove formed in an outer surface of the one of the first and second tubulars that does not comprise the first groove.

21. The apparatus of claim 13, wherein the first and second tubulars comprise carbon steel pipes.

22. An apparatus, comprising:
a first tubular;
a second tubular mated to the first tubular, wherein, when mated, the first and second tubulars are permitted to move axially relative to one another, wherein each of the first and second tubulars have an initial inside diameter and wherein the mated first and second tubulars are adapted to be radially expanded such that, after the radial expansion, the expanded mated first and second tubulars have an expanded inside diameter that is greater than the initial inside diameter of the mated first and second tubulars; and
a plurality of kerfs in an end of one of the first and second tubulars, wherein the kerfs define a plurality of radially-deflectable fingers that are adapted to deflect radially when the first and second tubulars are mated together.

23. The apparatus of claim 22, wherein the first and second tubulars are made of a metal-containing material.

24. The apparatus of claim 22, further comprising a first groove on the first tubular that is adapted to receive a protrusion on the second tubular, wherein the protrusion on the second tubular is allowed to move axially within the first groove in the expanded mated first and second tubulars.

25. The apparatus of claim 24, further comprising a second groove on the second tubular that is adapted to receive a protrusion on the first tubular, wherein the protrusion on the first tubular is allowed to move axially within the second groove in the expanded mated first and second tubulars.

26. The apparatus of claim 22, wherein the plurality of kerfs and the plurality of radially-deflectable fingers are formed on the first tubular, wherein the plurality of radially-deflectable fingers are positioned within the second tubular, and wherein the plurality of radially-deflectable fingers are adapted to deflect radially inward toward a centerline of the first tubular when the first and second tubulars are mated together.

27. The apparatus of claim 22, wherein the plurality of kerfs and the plurality of radially-deflectable fingers are formed on the second tubular and wherein the plurality of radially-deflectable fingers are adapted to deflect radially outward away from a centerline of the second tubular when the first and second tubulars are mated together.

28. The apparatus of claim 22, further comprising a locking ring positioned around the mated first and second tubulars at an area of engagement between the mated first and second tubulars.

29. The apparatus of claim 22, further comprising a seal positioned between the first and second tubulars.

30. A method, comprising:
positioning a first tubular adjacent a second tubular, each of the first and second tubulars having an initial inside diameter, one of the first and second tubulars comprising a plurality of radially-deflectable fingers formed in an end thereof;
mating the first and second tubulars into mated engagement with one another, wherein, during the mating of the first and second tubulars, the radially-deflectable fingers deflect in a radial direction and wherein, when mated, the first and second tubulars are permitted to move axially relative to one another; and
expanding the first and second tubulars by forcing an expansion mandrel through the mated first and second tubulars such that the expanded first and second tubulars have an expanded inside diameter that is greater than the initial inside diameter of the first and second tubulars.

31. A method, comprising:
positioning a first tubular adjacent a second tubular, each of the first and second tubulars having an initial inside diameter, one of the first and second tubulars comprising a plurality of radially-deflectable fingers formed in an end thereof;
mating the first and second tubulars into mated engagement with one another, wherein, during the mating of the first and second tubulars, the radially-deflectable fingers deflect in a radial direction and wherein, when mated, the first and second tubulars are permitted to move axially relative to one another;
positioning the mated first and second tubulars at a desired location within a well, wherein, at the desired location within the well, the first and second tubulars are in a first relative axial positon relative to one another;
moving at least one of the first and second tubulars so as to establish a second relative axial position between the first and second tubulars relative to one another; and
with the first and second tubulars in the second relative axial position, expanding the first and second tubulars by forcing an expansion mandrel through the mated first and second tubulars such that the expanded first and second tubulars have an expanded inside diameter that is greater than the initial inside diameter of the first and second tubulars.
